(19) United States
(12) Patent Application Publication
(10) Pub. No.: US 2006/0033910 A1
(43) Pub. Date: Feb. 16, 2006

(54) Multiplexed detection of analytes in fluid solution

(76) Inventors: Lei Sun, Santa Clara, CA (US); Xing Su, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/916,710

(22) Filed: Aug. 11, 2004

(51) Int. Cl. G01J 3/44; G01N 21/65

(52) U.S. Cl. 356/301

(57) ABSTRACT

Methods and devices for solution-based detection of molecular and cellular analytes in a sample using composite organic-inorganic nanoclusters (COINs) are provided. The nanoclusters include metallic colloids and a Raman-active organic compound. A metal that enhances the Raman signal from the organic compound is inherent in the nanoparticle. Since a wide variety of Raman-active organic compounds can be incorporated into the particle, highly parallel analyte detection can be performed.

### BACKGROUND OF THE INVENTION

1. Field of the Invention

The embodiments of the present invention relate generally to nanoclusters incorporating metallic particles and organic compounds and analyte detection by Raman spectroscopy.

2. Background Information

The expanding understanding of cellular and biologic function presents challenges to the management and practical use of the information acquired. For example, in a biochemical or clinical analysis, a principle challenge is to develop a system for distinguishing a large number of components of a sample rapidly and accurately. In addition, the ability to detect and identify trace quantities of analytes has become increasingly important in virtually every scientific discipline, ranging from part per billion analyses of pollutants in sub-surface water to analysis of drugs and metabolites in blood serum. Furthermore, despite the growth in scientific knowledge, much still remains to be unearthed regarding the genetic and protein basis of cellular function and dysfunction and devices and methods that accelerate the processes of elucidating the causes of disease, creating predictive and/or diagnostic assays, and developing effective therapeutic treatments are valuable scientific tools.

Among the many analytical techniques that can be used for chemical structure analysis, surface-enhanced Raman spectroscopy (SERS) is a sensitive method. A Raman spectrum, similar to an infrared spectrum, consists of a wavelength distribution of bands corresponding to molecular vibrations specific to the sample being analyzed. Raman spectroscopy probes vibrational modes of a molecule and the resulting spectrum, similar to an infrared spectrum, is fingerprint-like in nature. As compared to a fluorescence spectrum of a molecule which normally has a single peak with half peak width of tens of nanometers to hundreds of nanometers, a Raman spectrum has multiple structure-related peaks with half peak widths as small as a few nanometers.

To obtain a Raman spectrum, typically a beam from a light source, such as a laser, is focused on the sample generating inelastically scattered radiation which is optically collected and directed into a wavelength-dispersive spectrometer. Although Raman scattering is a relatively low probability event, SERS can be used to enhance signal intensity in the resulting vibrational spectrum. In SERS, analyte molecules are typically adsorbed onto noble metal nanoparticles. Although the electromagnetic enhancement has been shown to be related to the roughness of the metal surfaces or particle size when individual metal colloids are used, SERS is most effectively detected from aggregated colloids. These SERS techniques make it possible to obtain about a 10⁶ to 10¹⁴ fold signal enhancement.

Analyses for numerous chemicals and biochemicals by SERS have been demonstrated using: (1) activated electrodes in electrolytic cells; (2) activated gold colloid reagents; and (3) activated silver and gold substrates. However, many biomolecules such as proteins and nucleic acids do not have unique Raman signatures because these types of molecules are generally composed of a limited number of common monomers. Thus, a prerequisite for multiplex analyses in a complex sample is to have a coding system that possesses identifiers for a large number of analytes in the sample.

### BRIEF DESCRIPTION OF THE FIGURES

The following drawings are included to further demonstrate certain aspects of the disclosed embodiments of the invention. The embodiments may be better understood by reference to one or more of these drawings in combination with the detailed description presented herein.

FIG. 1 illustrates a method whereby SERS can be used as an amplification method to detect target molecules “A” and “B” according to their Raman signatures and compares this method to the use of COINs containing molecules “A” and “B” to detect molecules “C” and “D.”

FIG. 2 provides a comparison of the SERS spectrum of an organic molecule and the Raman spectrum of COINs created using the same Raman-active organic molecule. For each SERS test, 100 μL silver colloid including 4 μM 8-aza-adenine (AA) was mixed with 100 μL of a test reagent chosen from the following: water (control), N-benzoyl adenine (BA, a 10 μM solution); bovine serum albumen (BSA, a 1% solution); Tween™20 (Twn, a 1% solution); ethanol (Eth, 100%). A resulting 200 μM mixture was then mixed with either 100 μL of water (−Li) or 100 μL 0.34 M LiCl (+Li), before Raman spectra were obtained. Raman signal intensities were in arbitrary units and normalized to respective maximums. The same procedure was used for COINs made with 20 μM 8-aza-adenine, except that additional 8-aza-adenine was not used. FIG. 2A shows normalized SERS spectra of 8-aza-adenine with water as the test reagent, showing that salt was required and multiple major peaks were detected; arrows indicate peaks that were stronger than those in COINs; FIG. 2B shows normalized spectra from COINs using water as the test reagent; arrows indicate peaks that were reduced as compared to those from SERS; FIG. 2C shows bar graphs of SERS signal intensities at 1340 cm⁻¹ under the indicated testing conditions; FIG. 2D shows bar graphs of COIN signal intensities at 1340 cm⁻¹ under the indicated testing conditions.

FIGS. 3A-H show comparisons of Raman signals from traditional SERS (s) and COINs (c). For traditional SERS experiments, silver colloids containing 8-aza-adenine were mixed with a test reagent and either with water (−Li) or LiCl solution (+Li) before Raman scattering was measured. The same procedure was used for COINs containing 8-aza-adenine. (Key: BA=N-benzoyl adenine; BSA=bovine serum albumen, Twn=Tween™-20; eth=ethanol).

FIGS. 4A-D provide comparisons of traditional SERS spectra with COIN spectra. Examples of Raman labels as indicated (structures shown) were used for COIN synthesis. Raman spectra of COINs (C) were overlaid with spectra obtained from SERS (S), showing that COIN spectra can have different major peaks as compared with respective traditional SERS spectra. Spectra were normalized to respective maximums (in arbitrary units) to show relative peak intensities.

FIGS. 5A and 5B show signatures of COINs bearing one and three Raman labels, respectively. COINs were made with individual or mixtures of Raman labels at concentrations from 2.5 μM to 20 μM, depending on the signature desired. (Key: 8-aza-adenine (AA), 9-aminoacridine (AN), methylene blue (MB).) Representative peaks are indicated by arrows; peak intensities have been normalized to respective maximums; the Y axis values are in arbitrary units; spectra are offset by 1 unit from each other. FIG. 5A shows signatures of COINs made with a single Raman label, showing that each label produced a unique signature. FIG. 5B shows signatures of COINs made with mixtures of three Raman labels at concentrations that produced signatures as indicated: HLL means high peak intensity for AA (H) and low peak intensity for both AN (L) and MB (L); LHL means low peak intensity for AA (L), high peak intensity for AN (H) and low for MB (L); LLH means low for both AA (L) and AN (L) and high for MB (H). Note that peak heights can be adjusted by varying label concentrations, but they might not be proportional to the concentrations of the labels used due to different absorption affinities of the Raman labels for the metal surfaces.

FIGS. 6A and B show signatures of COINs with double and triple Raman labels. COINs were made by the oven incubation procedure with mixtures of 2 or 3 Raman labels at concentrations from 2.5 to 20 μM, depending on the signatures desired. The 3 Raman labels used were 8-aza-adenine (AA), 9-aminoacridine (AN), and methylene blue (MB). The main peak positions are indicated by arrows; the peak heights (in arbitrary units) were normalized to respective maximums; spectra are offset by 1 unit from each other. FIG. 6A shows signatures of COINs made with 2 Raman labels (AA and MB) at concentrations designed to achieve the following relative peak heights: AA=MB (HH), AA>MA (HL), and AA<MB (LH). FIG. 6B shows Raman signatures of COINs made from mixtures of the 3 Raman labels at concentrations that produced the following signatures: HHL means high peak intensities for AA (H) and AN (H) and low peak intensity for MB (L); HLH means high peak intensity for AA (H), low peak intensity for AN (L), and high peak intensity for MB (H); and LLH means low peak intensities for AA (L) and AN (L), and high peak intensity for MB (H). Other features could be revealed by computer analysis.

FIG. 7 is a schematic illustrating exemplary microspheres containing COINs and having an attached probe, such as a biomolecule.

FIG. 8 is a flow chart illustrating one method for producing microspheres containing COINs (the inclusion method).

FIG. 9 illustrates an alternative method for producing the microspheres containing COINs (the soak-in method).

FIG. 10 illustrates an additional method for creating the microspheres containing COINs (the build-in method).

FIG. 11 illustrates a further alternative method for creating the microspheres containing COINs (the build-out method).

FIG. 12 illustrates a use of COINs (composite organic-inorganic nanoparticles) as tags for analyte detection in solution. A magnetic microsphere labeled with an antibody specific for a protein analyte of interest is contacted with the protein analyte. A COIN-detection antibody conjugate is then added so that both the magnetic bead and the COIN are attached to the protein analyte. The bound protein analytes are then separated from solution magnetically, the uncomplexed COINs are removed, and the protein analyte is detected according to the intrinsic Raman signal from the bound COIN.

FIG. 13 illustrates a use of COINs as tags for cell-surface antigen identification. A sample containing a cell having various surface antigens is contacted with a COIN having attached antibodies specific for a known cell-surface antigen. The COIN attaches specifically to the known antigen. The cell is stained with a fluorescent dye. The cell is counted using fluorescent-based cell counting techniques, and the intrinsic Raman signal from the COIN is collected. The fluorescence signal is correlated with the Raman signal to determine the presence of the target cellular analyte in the sample.

FIGS. 14A and 14B show Raman spectra obtained from COIN binding experiments. FIG. 14A is a control experiment demonstrating that no binding occurred between a magnetic bead having no protein target and COIN(AAD) (a COIN incorporating 8-aza-adenine). FIG. 14B demonstrates that binding between a magnetic bead having an anti-IL2 capture antibody immobilized, IL2 protein (10 ng/mL) and a COIN(AAD)-Bt-a-IL2 (a COIN containing 8-aza-adenine and modified with anti-IL2 antibody) occurred.

FIGS. 15A and B show, respectively, the zeta potential measurements of silver particles of initial z-average size of 47 nm (0.10 M) with a suspending medium of 1.00 mM sodium citrate and evolution of aggregate size (z-average) in the presence of 20 μM 8-aza-adenine.

FIG. 16 is a schematic illustrating a detection scheme in which analyte detection is carried out in a vessel in which the sample contents are stirred so that an optical detector in a fixed position detects all the labeled analytes over period of time.

FIG. 17 schematically illustrates a detection scheme for concurrent fluorescence and Raman signal detection.

### DETAILED DESCRIPTION OF THE INVENTION

Solution-based detection of analytes, including highly parallel detection, can be performed, according to embodiments of the present invention, using Composite Organic-Inorganic Nanoclusters (COINs). COINs are a type of nanoparticle that produce intrinsic enhanced Raman signals when excited by light. A known analyte can be detected, for example, by contacting a sample containing the analyte with a nanoparticle of the present invention (a COIN) having an attached probe, such that the probe binds selectively to the analyte, separating uncomplexed COINs from analyte-bound COINs, and detecting the unique Raman signals emitted by the nanoparticle(s) such that the unique Raman signal(s) detected are indicative of the presence of the analyte in the sample.

Performing highly multiplexed detection using COINs is facilitated by an ability to incorporate a large variety of organic Raman active compounds into COINs. Not only can COINS be synthesized with different Raman labels, but COINs may also be created having different mixtures of Raman labels and also different ratios of Raman labels within the mixtures. Thus, it is possible to create a large number of different labels using the COINs of the present invention. Furthermore, not only are the intrinsic enhanced Raman signatures of the nanoparticles of the present invention sensitive reporters, but sensitivity may also be further enhanced by incorporating thousands of Raman labels into a single particle and/or attaching multiple nanoparticles to a single molecular analyte or cell surface.

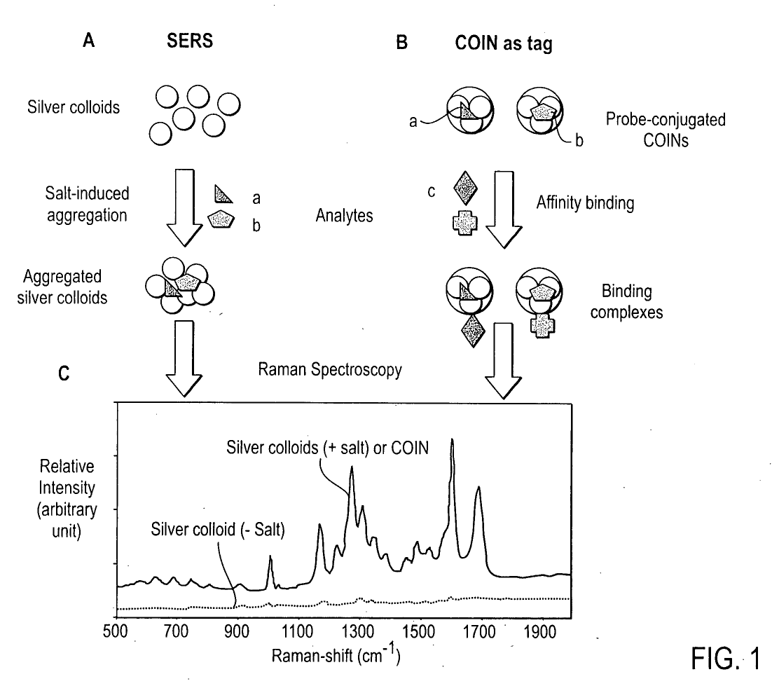

Although individual metal particles have been shown to produce SERS with an enhancement factor as large as 10¹⁴, the strongest Raman enhancements, such as those allowing the detection of single molecules, were shown to be associated with colloid clusters formed after salt-induced aggregation. As shown in FIG. 1A, SERS can be used as an amplification method to detect target molecules “A” and “B” according to their Raman signatures. In this experiment, colloids are deposited on or co-aggregated with an analyte and a resulting enhanced Raman spectrum of an analyte is obtained. The spectra of FIG. 1C shows that the SERS signal obtained after salt-induced colloid aggregation was at least 10 times stronger (top spectrum) than without salt addition (bottom spectrum, showing a hardly detectable signal).

The COINs of the present invention do not require an amplification procedure to function as sensitive reporters for analyte detection since Raman enhancement is intrinsic in the particle. The use of COINs as probes for molecular analytes is illustrated in FIG. 1B, in which 2 types of COINs are made from compounds “A” and “B,” and then functionalized with affinity probes specific for analytes “C” and “D,” respectively. The specific complexation of COINs having unique labels “A” and “B” allows analytes “C” and “D” to be detected.

COINs can be prepared by a physico-chemical process called Organic Compound Assisted Metal Fusion (OCAMF). Organic compounds can be absorbed on metal colloids and cause aggregation by changing the colloidal surface zeta potentials. It was found that the aggregated metal colloids fused at elevated temperature and that organic Raman labels could be incorporated into the coalescing metal particles. These coalesced metal particles form stable clusters to produce intrinsically enhanced Raman scattering signals for the incorporated organic label. It is believed that the interaction between the organic Raman label molecules and the metal colloids has mutual benefits. Besides serving as signal sources, the organic molecules promote and stabilize a metal particle association that is in favor of electromagnetic signal enhancement. Additionally, the internal cluster structure provides spaces to hold and stabilize Raman label molecules, especially in the junctions between the metal particles that make up the cluster. In fact, it is believed that the strongest enhancement is achieved from the organic molecules located in the junctions between the metal particles of the clusters.

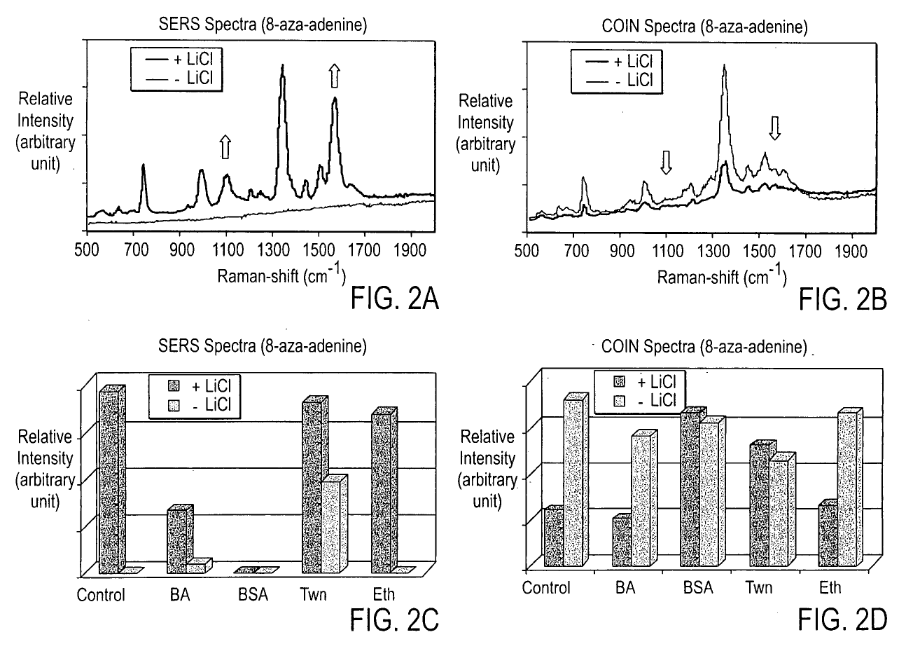

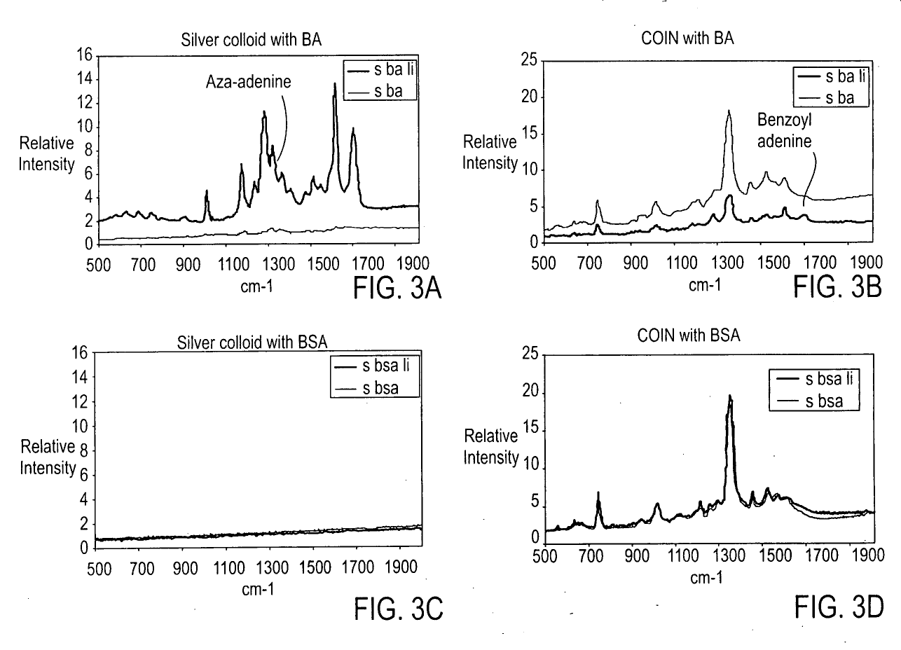

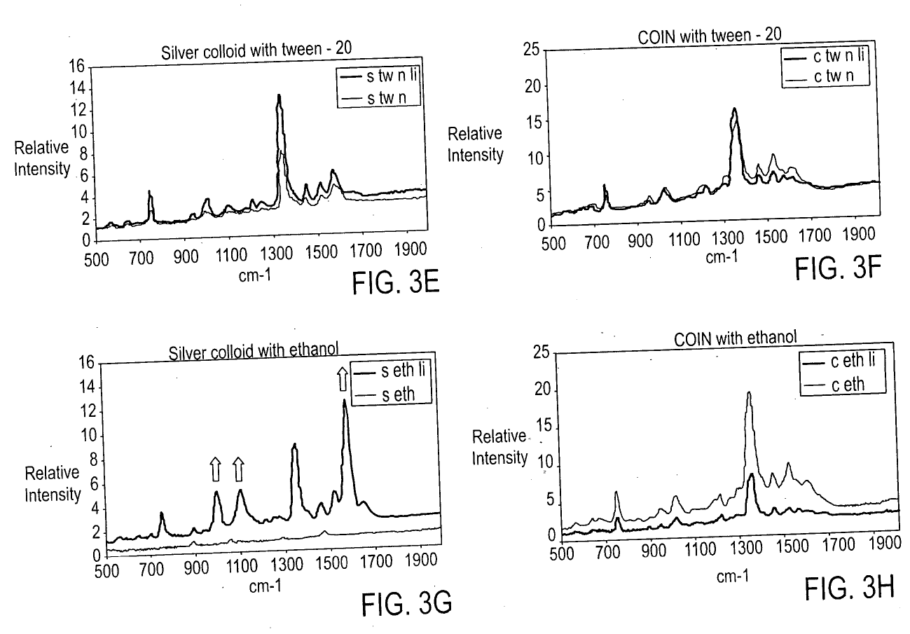

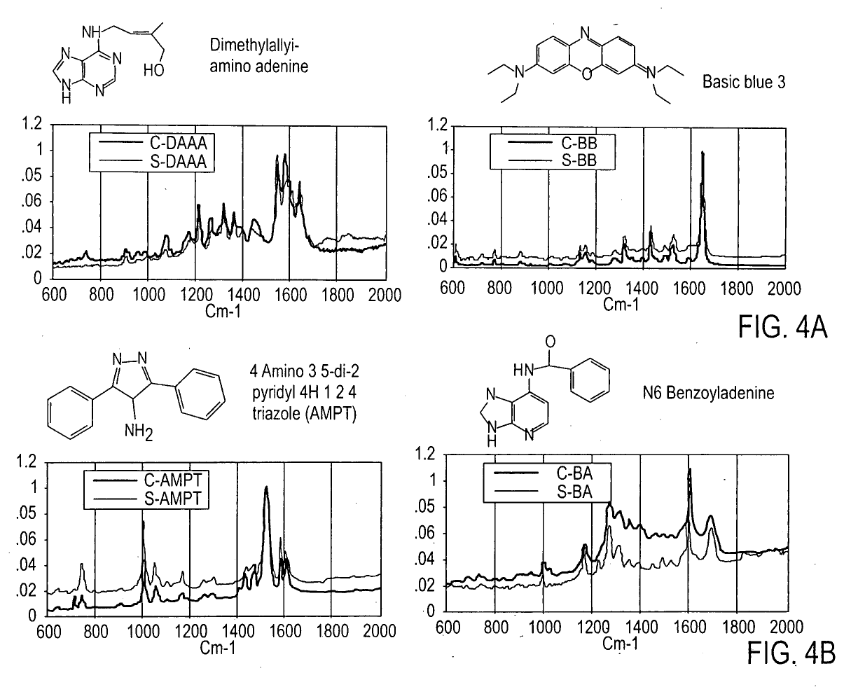

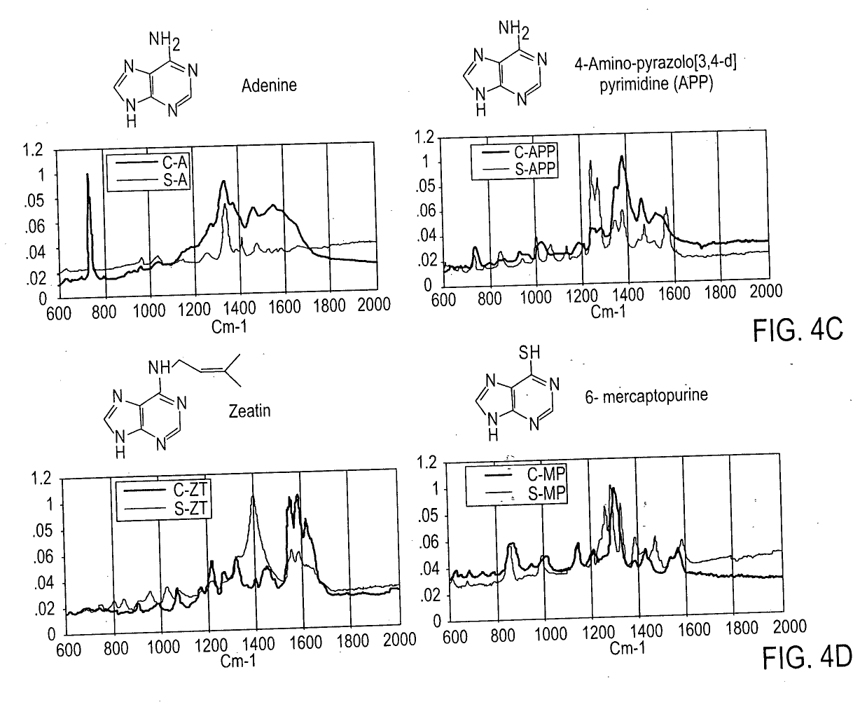

COINs generate an intrinsic enhanced Raman signal without additional reagents (such as salts) traditionally associated with obtaining a strong SERS signal. FIGS. 2A-2D compare spectra obtained from COINs under various conditions with spectra obtained from traditional SERS under similar conditions. FIG. 2A shows a typical Raman spectrum obtained by mixing 8-aza-adenine (AA) with silver colloids and a monovalent salt (LiCl, +Li). When the salt was omitted from the reaction (−Li), the SERS signal was not detectable. By contrast, a strong Raman signal was detected from a COIN sample with no salt added (FIG. 2B), and when LiCl (salt) was added, the Raman signal was greatly reduced (possibly due to the increased aggregation and sedimentation of the COINs). Compared with the typical SERS spectrum, the peaks at 1100 cm⁻¹ and 1570 cm⁻¹ disappeared almost completely from the COINs spectrum. In the case of one Raman label, 10 μM N-benzoyl adenine, negligible Raman enhancement was observed for COINs (see FIG. 3A-B). It was also observed that SERS spectra were completely suppressed by 0.3% BSA, and in contrast, signals from COINs did not change significantly in the presence of added BSA (regardless of the presence or absence of salt) (FIGS. 3C-D). Tween™-20, a nonionic surfactant commonly used in biochemical reactions, appeared to inhibit salt-induced aggregation but cause a low degree of colloid aggregation as observed in separate experiments. Referring now to FIG. 3, it was interesting to find that SERS reaction in the presence of 30% ethanol (plus salt) enhanced the peak height at 1550 cm⁻¹ compared with ethanol free reactions (FIG. 3G). On the other hand, COIN signals were equivalent to COIN in water in terms of spectra and relative peak intensities (FIGS. 2d and 3H). Spectral differences were also observed for other Raman labels that were tested (see examples in FIG. 4). These functional analyses show that COINs have distinct chemical and physical properties as compared to salt-induced colloid aggregates as used in typical SERS experiments.

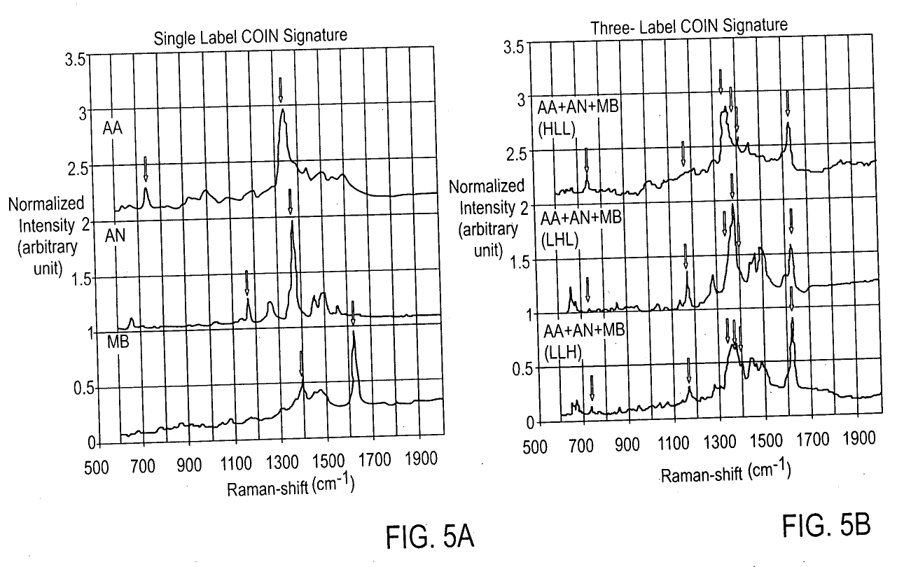

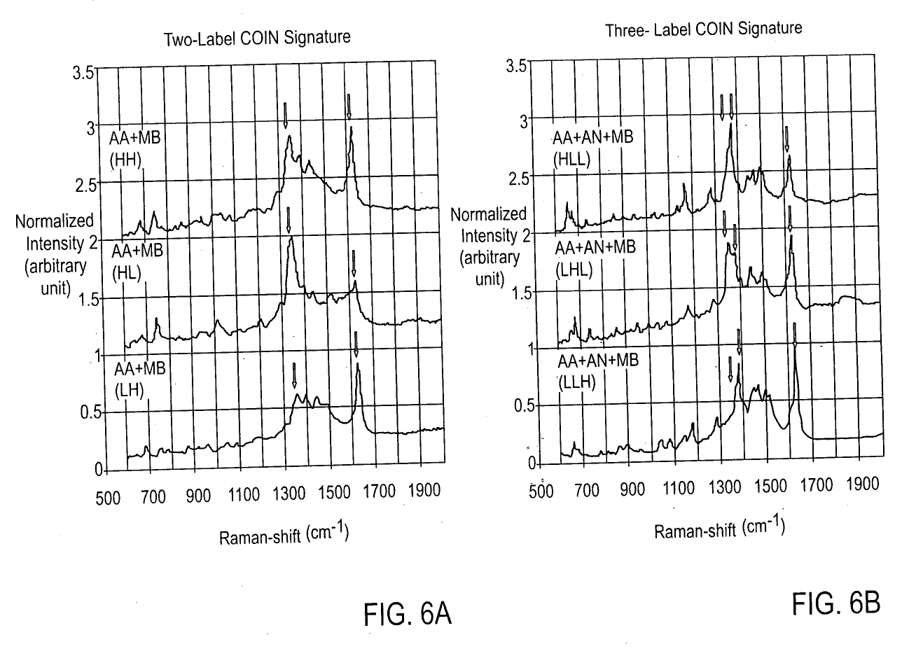

Using the OCAMF-based COIN synthesis chemistry, it is possible to generate a large number of different COIN signatures by mixing a limited number of Raman labels. Thus, COINs are especially suitable for use as identifiers in multiplexed assays. In a simplified scenario, the Raman spectrum of a sample labeled with COINs can be characterized by three parameters:
a) the peak position (designated as L), which depends on the chemical structure of the Raman labels used and the number of available labels,
b) the peak number (designated as M), which depends on the number of labels used together in a single coin, and
c) the peak height (designated as i), which depends on the ranges of relative peak intensities.
Thus, the total number of possible Raman signatures (designated as T) can be calculated from the following equation:

$$T = {\sum }_{k = 1}^{M} \frac{L !}{( L - k ) ! k !} P ( i , k ) \qquad ( 1 )$$

where P(i, k)=i^{k}−i+1, is the intensity multiplier which represents the number of distinct Raman spectra that can be generated by combining k (k=1 to M) labels for a given i value. To demonstrate that multiple labels can be mixed to make COINs, we tested the combinations of 3 Raman labels for COIN synthesis (L=3, M=3, and I=2). As shown in FIGS. 5 and 6, the results for 1 label, 2 labels, and 3 labels were all as expected. These spectral signatures demonstrated that closely positioned peaks (15 cm⁻¹ between AA and AN) could be resolved visually. In practical applications, mathematical and statistical methods can be used for signature recognition. Theoretically, over a million COIN signatures could be made within the Raman shift range of 500-2000 cm⁻¹.

Table 1 provides examples of the types of organic compounds that can be used to build COINs. In general, Raman-active organic compound refers to an organic molecule that produces a unique SERS signature in response to excitation by a laser. In certain embodiments, Raman-active organic compounds are polycyclic aromatic or heteroaromatic compounds. Typically the Raman-active compound has a molecular weight less than about 500 Daltons. In addition, these compounds can include fluorescent compounds or non-fluorescent compounds. Exemplary Raman-active organic compounds include, but are not limited to, adenine, 4-amino-pyrazolo(3,4-d)pyrimidine, 2-fluoroadenine, N6-benzolyadenine, kinetin, dimethyl-allyl-amino-adenine, zeatin, bromo-adenine, 8-aza-adenine, 8-azaguanine, 6-mercaptopurine, 4-amino-6-mercaptopyrazolo(3,4-d)pyrimidine, 8-mercaptoadenine, 9-amino-acridine, and the like. Additional, non-limiting examples of Raman-active organic compounds include TRIT (tetramethyl rhodamine isothiol), NBD (7-nitrobenz-2-oxa-1,3-diazole), Texas Red dye, phthalic acid, terephthalic acid, isophthalic acid, cresyl fast violet, cresyl blue violet, brilliant cresyl blue, para-aminobenzoic acid, erythrosine, biotin, digoxigenin, 5-carboxy-4′,5′-dichloro-2′,7′-dimethoxy fluorescein, 5-carboxy-2′,4′,5′,7′-tetrachlorofluorescein, 5-carboxyfluorescein, 5-carboxy rhodamine, 6-carboxyrhodamine, 6-carboxytetramethyl amino phthalocyanines, azomethines, cyanines, xanthines, succinylfluoresceins, aminoacridine, and the like. These and other Raman-active organic compounds may be obtained from commercial sources (such as, Sigma-Aldrich, St. Louis, Mo. and Molecular Probes, Eugene, Oreg.). In certain embodiments, the Raman-active compound is 8-aza-adenine, 4-amino-pyrazolo(3,4-d)pyrimidine, or 2-fluoroadenine.

Fluorescent compounds useful in the present invention include, but are not limited to, dyes, intrinsically fluorescent proteins, lanthanide phosphors, and the like. Dyes include, for example, rhodamine and derivatives, such as Texas Red, ROX (6-carboxy-X-rhodamine), rhodamine-NHS, and TAMRA (5/6-carboxytetramethyl rhodamine NHS); fluorescein and derivatives, such as 5-bromomethyl fluorescein and FAM (5′-carboxyfluorescein NHS), Cy dies such as Cy3, Cy3.5, Cy5, Cy5.5 (Amersham Biosciences), Lucifer Yellow, IAEDANS, 7-Me₂, N-coumarin-4-acetate, 7-OH-4-CH₃-coumarin-3-acetate, 7-NH₂-4-CH₃-coumarin-3-acetate (AMCA), monobromobimane, pyrene trisulfonates, such as Cascade Blue, and monobromotrimethyl-ammoniobimane.

The nanoparticles are readily prepared using standard metal colloid chemistry. Invention particles are less than 1 μm in size, and can be formed by particle growth in the presence of organic compounds. The preparation of such nanoparticles also takes advantage of the ability of metals to adsorb organic compounds. Indeed, since Raman-active organic compounds are adsorbed onto the metal during formation of the metallic colloids, many Raman-active organic compounds can be incorporated into a nanoparticle.

COINs can be prepared from an aqueous solution of primary metal particles and at least one suitable Raman-active organic compound. Primary metal particles can be prepared from a solution containing suitable metal cations and a reducing agent. The components of the solution are then subject to conditions that cause the formation of neutral colloidal metal particles. Since the formation of the metallic clusters occurs in the presence of a suitable Raman-active organic compound, the Raman-active organic compound is readily incorporated onto the metal cluster during formation. It is believed that the organic compounds trapped in the junctions between the primary metal particles provide the strongest Raman signal. These COINs are not usually spherical and often include grooves and protuberances and can typically be isolated by membrane filtration. In addition, COINs of different sizes can be enriched by centrifugation. Typical metals contemplated for use in formation of nanoparticles from metal colloids include, for example, silver, gold, platinum, copper, aluminum, and the like. In one embodiment the metal is silver or gold.

In a further embodiment of the invention, COINs include a second metal different from the first metal, wherein the second metal forms a layer overlying the surface of the nanoparticle. To prepare this type of nanoparticle, COINs are placed in an aqueous solution containing a suitable second metal (as a cation) and a reducing agent. The components of the solution are then subject to conditions that reduce the second metallic cations, thereby forming a metallic layer overlying the surface of the nanoparticle. In certain embodiments, the second metal layer includes metals, such as, for example, silver, gold, platinum, aluminum, copper, zinc, iron, and the like. COINs containing a second metal layer can be isolated and or enriched by membrane filtration and/or centrifugation. Typically, for applications such as fluid-based analyte detection, COINs range in average diameter from about 20 nm to about 200 nm, and more preferably COINs range in average diameter from about 30 to about 200 nm, and more preferably from about 40 to about 200 nm, more preferably from about 50 to about 200 nm, and more preferably about 50 to about 150 nm.

In certain embodiments, the metallic layer overlying the surface of the nanoparticle is referred to as a protection layer. This protection layer can contribute to the aqueous stability of the colloidal nanoparticles. As an alternative to metallic protection layers or in addition to metallic protection layers, COINs can be coated with a layer of silica. Silica deposition is initiated from a supersaturated silica solution, followed by growth of a silica layer by dropwise addition of ammonia and tetraethyl orthosilicate (TEOS). (See, for example, V. V. Hardikar and E. Matijevic, J. Colloid Interface Science, 221:133-136 (2000).) Additionally, the silica-coated COINs are readily functionalized using standard silica chemistry. For example, a silica-coated COIN can be derivatized with (3-aminopropyl)triethoxysilane to yield a silica coated COIN that presents an amine group for further coating, layering, modification, or probe attachment. (See, for example, Wong, C. Burgess, J., Ostafin, A, “Modifying the Surface Chemistry of Silica Nano-Shells for Immunoassays,” Journal of Young Investigators, 6:1 (2002), and Ye, Z., Tan, M., Wang, G., Yuan, J., “Preparation, Characterization, and Time-Resolved Fluorometric Application of Silica-Coated Terbium(III) Fluorescent Nanoparticles,” Anal. Chem., 76:513 (2004).) If the COINs have been coated with a metallic layer, such as for example, gold, a silica layer can be attached to the gold layer by vitreophilization of the COINs with, for example, coupling of 3-aminopropyltrimethoxysilane (APTMS) to the gold surface.

In alternative embodiments, hematite (α-Fe₂O₃) can be used as a coating layer. The hematite layer can be formed, for example, by placing hematite particles in a solution with COINs and allowing the hematite particles to associate with the surface of the COINs.

In certain other embodiments, COINs can include an organic layer overlying the metal layer or the silica layer. Typically, these types of nanoparticles are prepared by covalently attaching organic compounds to the surface of the metal layer in uni- or bimetallic COINs. Covalent attachment of an organic layer to a metal surface can be achieved in a variety ways well known to those skilled in the art, such as for example, through thiol-metal bonds. An organic layer can also be used to provide colloidal stability and functional groups for further derivatization. The organic layer is optionally crosslinked to form a solid coating. An exemplary organic layer is produced by adsorption of an octylamine modified polyacrylic acid onto COINs, the adsorption being facilitated by the positively charged amine groups. The carboxylic groups of the polymer are then crosslinked with a suitable agent such as lysine, (1,6)-diaminoheptane, or the like. Unreacted carboxylic groups can be used for further derivation. Other functional groups can be also introduced through the modified polyacrylic backbones.

In a further embodiment, the COIN or the COIN having a metal layer is coated with an adsorbed layer of protein. Suitable proteins include non-enzymatic soluble globular or fibrous proteins. For applications involving detecting molecules, the protein should be chosen so that it does not interfere with a detection assay, in other words, the proteins should not also function as competing or interfering probes in a user-defined assay. By non-enzymatic proteins is meant molecules that do not ordinarily function as biological catalysts. Examples of suitable proteins include avidin, streptavidin, bovine serum albumen (BSA), insulin, soybean protein, casine, gelatine, and the like, and mixtures thereof. For a COIN having a BSA layer, the adsorbed BSA affords several potential functional groups, such as, carboxylic acids, amines, and thiols, for further functionalization or probe attachment. Optionally, the protein layer can be cross-linked with EDC (1-ethyl-3-(3-dimethyl aminopropyl)carbodiimide), or with glutaraldehyde followed by reduction with sodium borohydride.

An adsorption layer can provide COINs with increased stability and can make additional sites available for attachment of probes. Probes can be covalently attached to the BSA layer through, for example, coupling via water-soluble carbodiimide reagents, such as EDC, which couples carboxylic acid functional groups with amine groups. For COINs having a coating comprising avidin or a mixture of avidin and BSA, probes can be attached to the COIN, for example, through biotin-avidin coupling.

Further, the metal and organic coatings can be overlaid in various combinations to provide desired properties for the COINs. For example, silver COINs may be first coated with a gold layer before applying the adsorption layer, silica, or solid organic coatings. Even if the outer layer is porous, a non-porous inner gold layer can shield COINs from chemical attack by reagents that may be present in particular applications. In a further embodiment, an adsorption layer is applied on a silica or gold layer to provide additional colloidal stability.

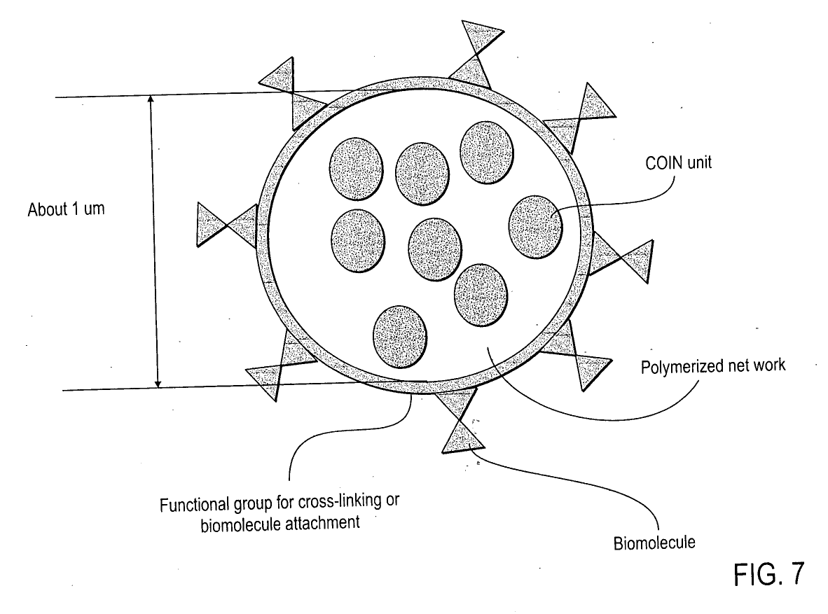

In another embodiment of the invention, there are provided microspheres comprising a plurality of invention COINs embedded and held together within a polymeric bead. Such microspheres produce stronger and more consisted Raman signals than individual COINs or nanoparticle clusters or aggregates. The large microsphere can also provide added surface areas for biomolecule attachment, such as probes. The structural features are a) a framework formed by polymerized organic compounds; b) multiple COINs or nanoparticle clusters embedded in each micro-sized particle; c) a surface with suitable functional groups for attachment of desired molecules, such as linkers, probes, and the like (as shown in FIG. 7). Several methods for producing microspheres according to this embodiment are set forth below.

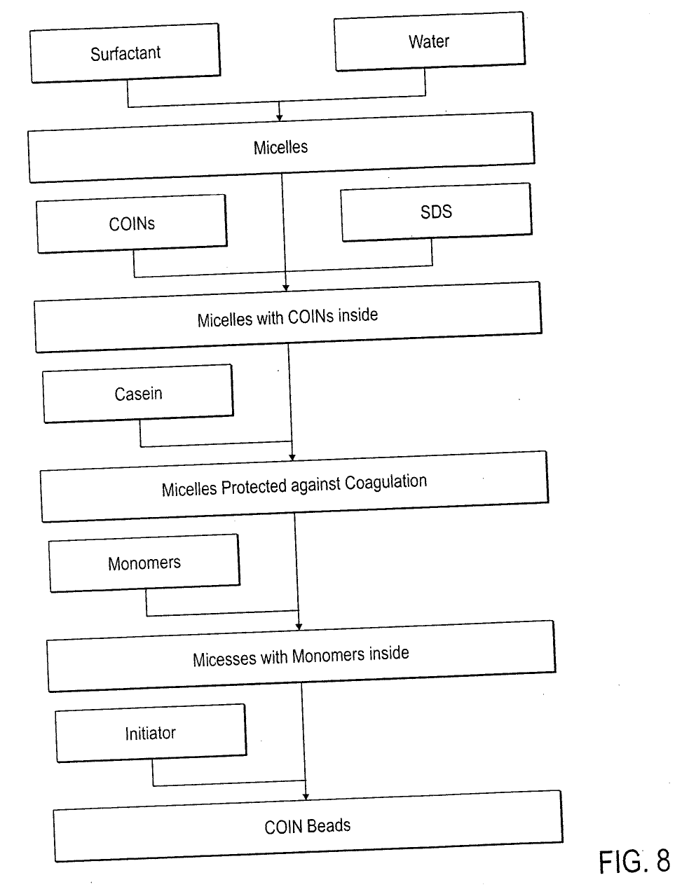

Inclusion Method (FIG. 8): This approach employs the well established emulsion polymerization technique for preparing uniform latex microspheres except that COINs are introduced into the micelles before polymerization is initiated. As shown in the flow chart of FIG. 8, this aspect of the invention methods involves the following: 1) Micelles of desired dimensions are first prepared by homogenization of water with surfactants (for example, octanol). 2) COINS particles are introduced along with a hydrophobic agent (for example, SDS). The latter facilitates the transport of COINs into the interior of micelles. 3) Micelles are protected against aggregation with a stabilizing agent (for example, Casein). 4) Monomers (for example, styrene or methyl methacrylate) are introduced. 5) Finally, a free radical initiator (for example, peroxide or persulfate) is used to start the polymerization to produce COIN embedded latex beads.

An important refinement of the above approach is to use COINs that have been coated with a solid organic polymer layer or clusters of COIN particles or clusters in the micelles and in the final product (microsphere). The coating can prevent direct contact between COIN particles in the micelles and in the final product (COIN beads). Furthermore, the number of COINs in each bead can be adjusted by varying the thickness of organic coating. The function of the polymer material of the bead is structural; the polymer is not needed for signal generation.

The microspheres are up to microns in size and each operates as a functional unit having a structure comprising many individual COINs held together by the structural polymer of the bead. Typically, within a single microsphere, there are several COINs embedded in the structural polymer that is the main inner and outer structural material of the bead. The structural polymer also functions as a surface for derivatizing, attaching probes, attaching linkers, or for further functionalizing for attachment of probes, linkers, etc. Since each COIN comprises a cluster of primary metal particles with Raman-active organic compound that are chiefly trapped in the junctions of the primary metal particles or embedded in between the metal atoms of the COIN structure, the polymer of the bead largely does not contact the Raman-active compounds. Those Raman-active organic molecules on the periphery of the COINs that contact the structural polymer of the microsphere appear to have reduced effect as Raman-active molecules.

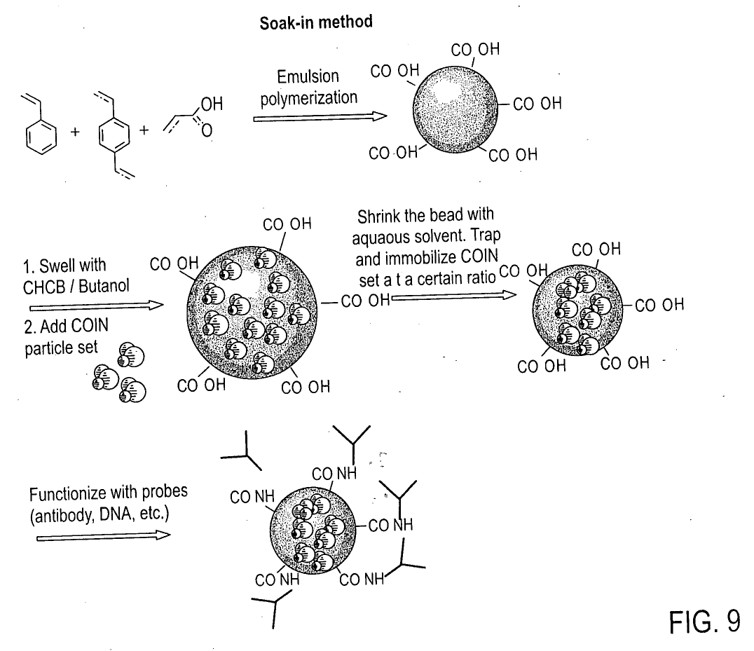

Soak-in Method (FIG. 9): Microspheres are obtained first and allowed to contact COINs that are synthesized separately. Under certain conditions, such as in an organic solvent, the pores of the beads are enlarged enough to allow COINs to diffuse inside. After the liquid phase is changed to an aqueous phase, the pores of the beads contract, embedding the COINs within the polymer beads. For example, 1) Styrene monomers are co-polymerized with divinylstyrene and acrylic acid to form uniformly-sized beads through emulsion polymerization. 2) The beads are swelled with organic solvents such as chloroform/butanol, and a set of COINs at a certain ratio are introduced so that the COINs diffuse into the swollen bead. 3) The beads are then placed in a non-solvent to shrink the beads so that the COINs are trapped inside to form stable, uniform COIN-encapsulated beads.

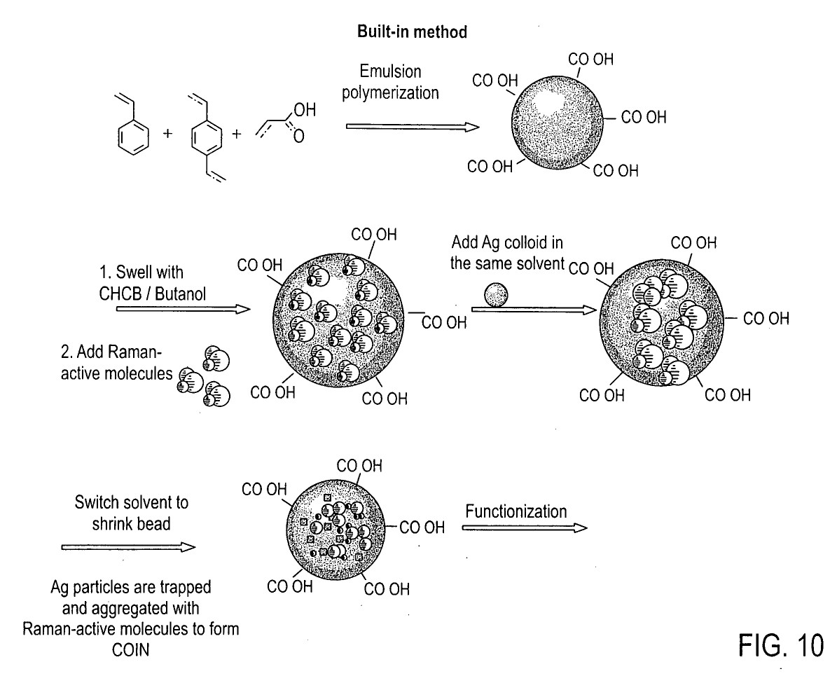

Build-in Method (FIG. 10): In this method, microsphere beads are obtained first and are placed in contact with Raman labels and silver colloids in organic solvents. Under this condition, the pores of the beads are enlarged enough to allow the labels and silver colloids to diffuse inside. Then COIN clusters are formed inside the microsphere beads when silver colloids encounter each other in the presence of organic Raman labels. Heat and light can be used to accelerate aggregation and fusion of silver particles. Finally, the liquid phase is changed to aqueous phase, the COINs are encapsulated. For example, 1) Styrene monomers are co-polymerized with divinylstyrene and acrylic acid to form uniformly-sized beads through emulsion polymerization. 2) The beads are then swelled with organic solvents such as chloroform/butanol, and the desired Raman-active molecules (for example, 8-azaadenine and N-benzoyladenine) at a certain ratio (if more than one type is used) are introduced so that the molecules diffuse into the swollen bead. Silver colloid suspension in the same solvent is then mixed with the beads to form Ag particle-encapsulated beads. 3) The solvent is switched to one that shrinks the beads so that the Raman labels and Silver particles are trapped inside. The process can be controlled so that the Silver particles will contact each other with Raman molecules in the junction, forming COIN inside the beads. When medium size silver colloids, such as 60 nm colloids, are used, Raman labels are added separately (before or after silver addition) to induce colloid aggregation (formation of COINs) inside the beads, when 1-10 nm colloids are used, the labels can be added together, then light or heat is used to induce the formation of active COINs inside the beads.

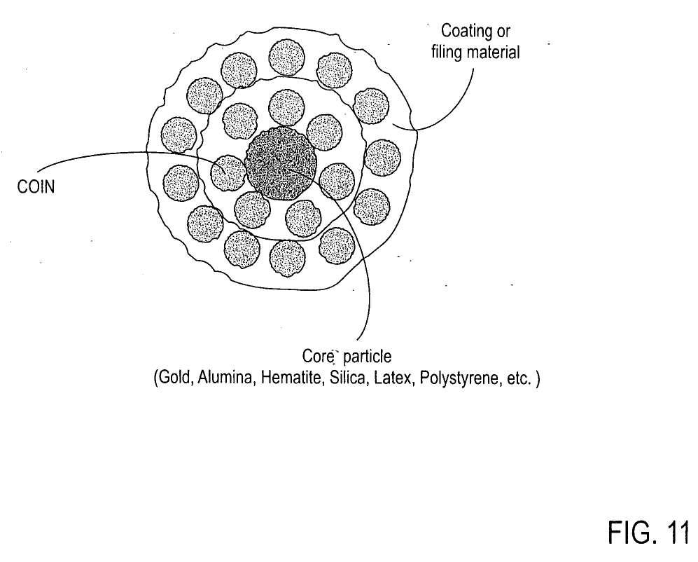

Build-out Method (FIG. 11): In this method, a solid core is used first as the support for COIN attachment. The core can be metal (gold and silver) particles, inorganic (alumina, hematite, and silica) or organic (polystyrene, latex) particles. Attachment of COINs to the core particle can be induced by electrostatic attraction, van der Waals forces, and/or covalent binding. After the attachment, the assembly can be coated with a polymer to stabilize the structure and at the same time to provide a surface with functional groups. Multiple layers of COINs can be built based on the above procedure. The dimension of COIN beads can be controlled by the size of the core and the number of COIN layers. For example, 1) positively charged Latex particles of 0.5 μm are mixed with negatively charged COINs. 2) The Latex-COIN complex is coated with a cross-linkable polymer such as poly-acrylic acid. 3) The polymer coating is cross-linked with linker molecules such as lysine to form an insoluble shell. Remaining (unreacted) carboxylic groups can serve as the functional groups for second layer COIN attachment or probe attachment. Additional functional groups can also be introduced through co-polymerization or during the cross-linking process.

Analyte Detection

In one embodiment, the invention provides fluid-based methods for detecting a known analyte in a sample by contacting the sample containing the analyte with a solution containing COINs, the COINs having a unique Raman signature produced by at least one Raman-active organic compound incorporated therein and also having a probe that binds specifically to the analyte of interest. A microsphere carrier is also specifically bound to the analyte of interest. The complexed analytes are separated from uncomplexed COINs and the Raman signatures of the COINs that specifically bound an analyte are detected. The detection of a Raman signal indicates the presence of a known analyte in the sample.

In another embodiment, the invention provides fluid-based methods for detecting two or more analytes in a sample by contacting a sample comprising a plurality of analytes with a set of COINs, each member of the set having a Raman signature unique to the set and an attached probe that binds specifically to a unique analyte present in the sample. Microsphere carriers are also specifically bound to the analytes of interest. The complexed COINs are separated from uncomplexed COINs and Raman signatures from the Raman active compounds are detected in multiplex fashion from a fluid solution. Each Raman signal indicates the presence of a known analyte in the sample.

In an additional embodiment, detection of a known analyte is performed by complexing a set of two different COINs, each having a unique Raman label produced by a Raman active organic compound incorporated therein, to an analyte, diluting the sample so that there is one molecule or less present in a detection cavity, and detecting Raman signals from the fluid. The concurrent detection of two unique Raman labels indicates the presence of the analyte in the sample. In a further embodiment, two or more known analytes in a sample are detected by complexing a set of two COINs having unique Raman labels to each analyte, diluting the sample so that there is one molecule or less present in the detection cavity, and detecting Raman signals from a solution containing the COIN-complexed analytes. The detection of two unique Raman labels indicates the presence of an analyte in the sample.

The COINs of the present invention can perform as sensitive reporters for use in fluid-based molecular analyte detection, and also for highly parallel fluid-based molecular analyte detection. A set of COINs can be created in which each member of the set has a Raman signature unique to the set. Any of the types of COINs as discussed herein can be used for analyte detection. In general, as described herein, COINs are composed of clusters of metal particles containing organic Raman-active compounds. COINs useful for fluid-based applications generally range in average diameter from about 20 nm to about 200 nm. Additionally, COINs may also include layers and modifications, such as, for example, an adsorption layer, an organic coating, a metal coating, a silica coating, or various combinations thereof. Further, the COINs can be embedded in polymeric beads.

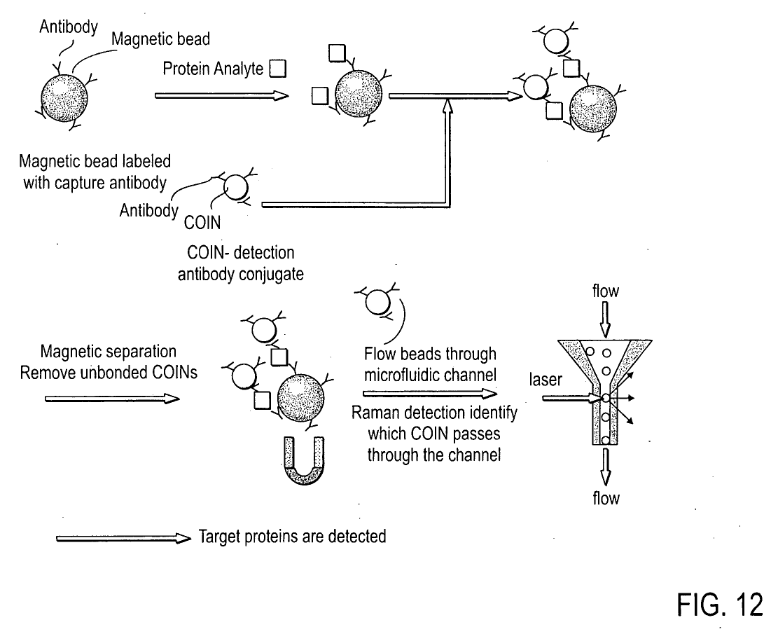

COINs can be complexed to the molecular analyte through a probe attached to the COIN. In general, a probe is a molecule that is able to specifically bind an analyte and, in certain embodiments, exemplary probes are antibodies, antigens, polynucleotides, oligonucleotides, carbohydrates, proteins, receptors, ligands, peptides, inhibitors, activators, hormones, cytokines, cofactors, and the like. In the example shown in FIG. 12, the analyte is a protein and the COIN is complexed to the analyte through an antibody that specifically recognizes the protein analyte of interest.

In some embodiments, a probe is an antibody. As used herein, the term antibody is used in its broadest sense to include polyclonal and monoclonal antibodies, as well as antigen binding fragments of such antibodies. An antibody useful the present invention, or an antigen binding fragment thereof, is characterized by having specific binding activity for an epitope of an analyte. An antibody, for example, includes naturally occurring antibodies as well as non-naturally occurring antibodies, including, for example, single chain antibodies, chimeric, bifunctional, and humanized antibodies, as well as antigen-binding fragments thereof. Such non-naturally occurring antibodies can be constructed using solid phase peptide synthesis, can be produced recombinantly, or can be obtained, for example, by screening combinatorial libraries consisting of variable heavy chains and variable light chains. These and other methods of making, for example, chimeric, humanized, CDR-grafted, single chain, and bifunctional antibodies are well known to those skilled in the art.

The terms binds specifically or specific binding activity, when used in reference to an antibody, mean that an interaction of the antibody and a particular epitope has a dissociation constant of at least about 1×10⁻⁶, generally at least about 1×10⁻⁷, usually at least about 1×10⁻⁸, and particularly at least about 1×10⁻⁹ or 1×10⁻¹⁰ or less. As such, Fab, F(ab′)₂, Fd and Fv fragments of an antibody that retain specific binding activity for an epitope of an antigen, are included within the definition of an antibody.

The term ligand implies a naturally occurring specific binding partner of a receptor, a synthetic specific-binding partner of a receptor, or an appropriate derivative of the natural or synthetic ligands. As one of skill in the art will recognize, a molecule (or macromolecular complex) can be both a receptor and a ligand. In general, the binding partner having a smaller molecular weight is referred to as the ligand and the binding partner having a greater molecular weight is referred to as a receptor.

By analyte is meant any molecule or compound. An analyte can be in the solid, liquid, gaseous or vapor phase. By gaseous or vapor phase analyte is meant a molecule or compound that is present, for example, in the headspace of a liquid, in ambient air, in a breath sample, in a gas, or as a contaminant in any of the foregoing. It will be recognized that the physical state of the gas or vapor phase can be changed by pressure, temperature as well as by affecting surface tension of a liquid by the presence of or addition of salts etc.

The analyte can be comprised of a member of a specific binding pair (sbp) and may be a ligand, which is monovalent (monoepitopic) or polyvalent (polyepitopic), usually antigenic or haptenic, and is a single compound or plurality of compounds which share at least one common epitopic or determinant site. The analyte can be derived from a cell such as bacteria or a cell bearing a blood group antigen such as A, B, D, etc., or an HLA antigen or a microorganism, for example, bacterium, fungus, protozoan, prion, or virus. In certain aspects of the invention, the analyte is charged. A biological analyte could be, for example, a protein, a carbohydrate, or a nucleic acid.

A member of a specific binding pair (a sbp member) is one of two different molecules, having an area on the surface or in a cavity which specifically binds to and is thereby defined as complementary with a particular spatial and polar organization of the other molecule. The members of the specific binding pair are referred to as ligand and receptor (antiligand) or analyte and probe. Therefore, a probe is a molecule that specifically binds an analyte. These will usually be members of an immunological pair such as antigen-antibody, although other specific binding pairs such as biotin-avidin, hormones-hormone receptors, IgG-protein A, polynucleotide pairs such as DNA-DNA, DNA-RNA, and the like are not immunological pairs but are included in the invention and the definition of sbp member.

Specific binding is the specific recognition of one of two different molecules for the other compared to substantially less recognition of other molecules. Generally, the molecules have areas on their surfaces or in cavities giving rise to specific recognition between the two molecules. Exemplary of specific binding are antibody-antigen interactions, enzyme-substrate interactions, polynucleotide hybridization interactions, and so forth.

Non-specific binding is non-covalent binding between molecules that is relatively independent of specific surface structures. Non-specific binding may result from several factors including hydrophobic interactions between molecules.

In some embodiments, the probe can be a polynucleotide probe. A COIN-labeled oligonucleotide probe can be used in a hybridization reaction to detect a target polynucleotide. The term polynucleotide is used broadly herein to mean a sequence of deoxyribonucleotides or ribonucleotides that are linked together by a phosphodiester bond. Generally, an oligonucleotide useful as a probe or primer that selectively hybridizes to a selected nucleotide sequence is at least about 10 nucleotides in length, usually at least about 15 nucleotides in length, for example between about 15 and about 50 nucleotides in length. Polynucleotide probes are particularly useful for detecting complementary polynucleotides in a biological sample and can also be used for DNA sequencing by pairing a known polynucleotide probe with a known Raman-active signal made up of a combination of Raman-active organic compounds as described herein.

A polynucleotide can be RNA or DNA, and can be a gene or a portion thereof, a cDNA, a synthetic polydeoxyribonucleic acid sequence, or the like, and can be single stranded or double stranded, as well as a DNA/RNA hybrid. In various embodiments, a polynucleotide, including an oligonucleotide (for example, a probe or a primer) can contain nucleoside or nucleotide analogs, or a backbone bond other than a phosphodiester bond. In general, the nucleotides comprising a polynucleotide are naturally occurring deoxyribonucleotides, such as adenine, cytosine, guanine or thymine linked to 2′-deoxyribose, or ribonucleotides such as adenine, cytosine, guanine or uracil linked to ribose. However, a polynucleotide or oligonucleotide also can contain nucleotide analogs, including non-naturally occurring synthetic nucleotides or modified naturally occurring nucleotides. One example of an oligomeric compound or an oligonucleotide mimetic that has been shown to have good hybridization properties is referred to as a peptide nucleic acid (PNA). In PNA compounds, the sugar-backbone of an oligonucleotide is replaced with an amide containing backbone, for example an aminoethylglycine backbone. In this example, the nucleobases are retained and bound directly or indirectly to an aza nitrogen atom of the amide portion of the backbone. PNA compounds are disclosed in Nielsen et al., Science, 254: 1497-15 (1991), for example.

The covalent bond linking the nucleotides of a polynucleotide generally is a phosphodiester bond. However, the covalent bond also can be any of a number of other types of bonds, including a thiodiester bond, a phosphorothioate bond, a peptide-like amide bond or any other bond known to those in the art as useful for linking nucleotides to produce synthetic polynucleotides. The incorporation of non-naturally occurring nucleotide analogs or bonds linking the nucleotides or analogs can be particularly useful where the polynucleotide is to be exposed to an environment that can contain nucleolytic activity, including, for example, a tissue culture medium or upon administration to a living subject, since the modified polynucleotides can be less susceptible to degradation.

As used herein, the terms selective hybridization or selectively hybridize, refer to hybridization under moderately stringent or highly stringent conditions such that a nucleotide sequence preferentially associates with a selected nucleotide sequence over unrelated nucleotide sequences to a large enough extent to be useful in identifying the selected nucleotide sequence. In the event that some amount of non-specific hybridization occurs, such non-specific hybridization is acceptable provided that hybridization to a target nucleotide sequence is sufficiently selective such that it can be distinguished over the non-specific cross-hybridization, for example, at least about 2-fold more selective, generally at least about 3-fold more selective, usually at least about 5-fold more selective, and particularly at least about 10-fold more selective, as determined, for example, by an amount of labeled oligonucleotide that binds to target nucleic acid molecule as compared to a nucleic acid molecule other than the target molecule, particularly a substantially similar nucleic acid molecule other than the target nucleic acid molecule. Conditions that allow for selective hybridization can be determined empirically, or can be estimated based, for example, on the relative GC:AT content of the hybridizing oligonucleotide and the sequence to which it is to hybridize, the length of the hybridizing oligonucleotide, and the number, if any, of mismatches between the oligonucleotide and sequence to which it is to hybridize.

An example of progressively higher stringency conditions is as follows: 2×SSC/0.1% SDS at about room temperature (hybridization conditions); 0.2×SSC/0.1% SDS at about room temperature (low stringency conditions); 0.2×SSC/0.1% SDS at about 42° C. (moderate stringency conditions); and 0.1×SSC at about 68 C (high stringency conditions). Washing can be carried out using only one of these conditions, for example, high stringency conditions, or each of the conditions can be used, for example, for 10-15 minutes each, in the order listed above, repeating any or all of the steps listed. However, as mentioned above, optimal conditions will vary, depending on the particular hybridization reaction involved, and can be determined empirically.

In general, probes can be attached to metal-coated COINs through adsorption of the probe to the COIN surface. Alternatively, COINs may be coupled with probes through biotin-avidin linkages. For example, avidin or streptavidin (or an analog thereof) can be adsorbed to the surface of the COIN and a biotin-modified probe contacted with the avidin or streptavidin-modified surface forming a biotin-avidin (or biotin-streptavidin) linkage. As discussed above, optionally, avidin or streptavidin may be adsorbed in combination with another protein, such as BSA, and optionally be crosslinked. In addition, for COINs having a functional layer that includes a carboxylic acid or amine functional group, probes having a corresponding amine or carboxylic acid functional group can be attached through water-soluble carbodiimide coupling reagents, such as EDC (1-ethyl-3-(3-dimethyl aminopropyl)carbodiimide), which couples carboxylic acid functional groups with amine groups. Further, functional layers and probes can be provided that possess reactive groups such as, esters, hydroxyl, hydrazide, amide, chloromethyl, aldehyde, epoxy, tosyl, thiol, and the like, which can be joined through the use of coupling reactions commonly used in the art. For example, Aslam, M. and Dent, A., Bioconjugation: Protein Coupling Techniques for the Biomedical Sciences, Grove's Dictionaries, Inc., (1998) provides additional methods for coupling biomolecules, such as, for example, thiol maleimide coupling reactions, amine carboxylic acid coupling reactions, amine aldehyde coupling reactions, biotin avidin (and derivatives) coupling reactions, and coupling reactions involving amines and photoactivatable heterobifunctional reagents.

Nucleotides attached to a variety of functional groups may be commercially obtained (for example, from Molecular Probes, Eugene, Oreg.; Quiagen (Operon), Valencia, Calif.; and IDT (Integrated DNA Technologies), Coralville, Iowa) and incorporated into oligonucleotides or polynucleotides. Biotin-modified nucleotides are commercially available (for example, from Pierce Biotechnology, Rockford, Ill., or Panomics, Inc. Redwood City, Calif.) and modified nucleotides can be incorporated into nucleic acids during conventional amplification techniques. Oligonucleotides may be prepared using commercially available oligonucleotide synthesizers (for example, Applied Biosystems, Foster City, Calif.). Additionally, modified nucleotides may be synthesized using known reactions, such as for example, those disclosed in, Nelson, P., Sherman-Gold, R, and Leon, R, “A New and Versatile Reagent for Incorporating Multiple Primary Aliphatic Amines into Synthetic Oligonucleotides,” Nucleic Acids Res., 17:7179-7186 (1989) and Connolly, B., Rider, P. “Chemical Synthesis of Oligonucleotides Containing a Free Sulfhydryl Group and Subsequent Attachment of Thiol Specific Probes,” Nucleic Acids Res., 13:4485-4502 (1985). Alternatively, nucleotide precursors may be purchased containing various reactive groups, such as biotin, hydroxyl, sulfhydryl, amino, or carboxyl groups. After oligonucleotide synthesis, COINs may be attached using standard chemistries. Oligonucleotides of any desired sequence, with or without reactive groups for COIN attachment, may also be purchased from a wide variety of sources (for example, Midland Certified Reagents, Midland, Tex.).

Probes, such as polysaccharides, may be attached to COINs, for example, through methods disclosed in Aslam, M. and Dent, A., Bioconjugation: Protein Coupling Techniques for the Biomedical Sciences, Grove's Dictionaries, Inc., 229, 254 (1998). Such methods include, but are not limited to, periodate oxidation coupling reactions and bis-succinimide ester coupling reactions.

The nanoparticles of the present invention may be used to detect the presence of a particular target analyte, for example, a protein, enzyme, polynucleotide, carbohydrate, antibody, antigen, or combinations thereof. Biological analytes include, for example, components of bacteria, viruses, chromosomes, genes, mitochondria, nuclei, cell membranes and the like. The nanoparticles may also be used to screen bioactive agents, for example, drug candidates, for binding to a particular target or to detect agents like pollutants. As discussed above, any analyte for which a probe moiety, such as a peptide, protein, or aptamer, may be designed can be used in combination with the disclosed nanoparticles.

Molecular analytes include antibodies, antigens, polynucleotides, oligonucleotides, proteins, enzymes, polypeptides, polysaccharides, receptors, ligands, and the like. The analyte may be a molecule found directly in a sample such as a body fluid from a host. The sample can be examined directly or may be pretreated to render the analyte more readily detectible. Furthermore, the analyte of interest may be determined by detecting an agent probative of the analyte of interest such as a specific binding pair member complementary to the analyte of interest, whose presence will be detected only when the analyte of interest is present in a sample. Thus, the agent probative of the analyte becomes the analyte that is detected in an assay. The body fluid can be, for example, urine, blood, plasma, serum, saliva, semen, stool, sputum, cerebral spinal fluid, tears, mucus, and the like. Methods for detecting target nucleic acids are useful for detection of infectious agents within a clinical sample, detection of an amplification product derived from genomic DNA or RNA or message RNA, or detection of a gene (cDNA) insert within a clone. Detection of the specific Raman label from a COIN labeled oligonucleotide probe identifies the nucleotide sequence of the oligonucleotide probe, which in turn provides information regarding the nucleotide sequence of the target polynucleotide.

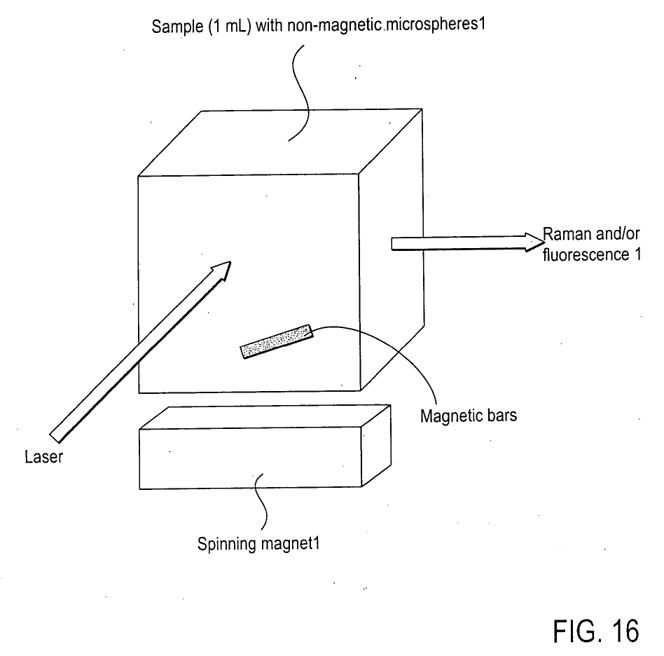

In one embodiment, microsphere carriers having an attached probe are contacted with the analyte solution and used to separate target analytes from uncomplexed COINs. The microsphere carriers are complexed to the analytes of interest via the types of probes and specific binding interactions discussed above for the complexation of COINs to analytes. For example, the complexation of a microsphere to a target analyte can occur through antibodies, receptors, inhibitors, activators, hormones, or nucleic acid probes. Thus, if antibodies are used, the microsphere is conjugated to one or more antibodies that recognize a first epitope on the target molecule, and the COIN is conjugated to one or more antibodies that recognize a second epitope on the same target molecule. In an alternate example, the COIN is conjugated to a ligand and the microsphere is conjugated to an antibody that recognizes the receptor for the ligand, or vice versa. If the target analyte is a polynucleotide, the COIN is conjugated to an oligonucleotide probe complementary to a section of the polynucleotide and the microsphere is conjugated to an oligonucleotide probe that recognizes a different section of the target polynucleotide. The microsphere carriers can be, for example, latex, polystyrene, agarose, or surface-coated magnetic beads. The microspheres typically are about 0.1 to about 50 μm, preferably about 0.5 to about 25 μm, and more preferably about 1 to about 10 μm in diameter. Useful microspheres are available from, for example, Polysciences, Warrington, Pa.; Dynal Biotech Inc., Brown Deer, Wis.; Magsphere, Inc., Pasadena, Calif.; and Bangs Laboratories, Inc., Fishers, Ind. Microspheres that allow for size-based separation of the microspheres from the uncomplexed COINs are useful in the present invention. Optionally, the microsphere carriers may contain a Raman label, such as COINs, or a fluorescent label. Microsphere carriers can be conjugated with capture antibody probes or nucleic acid probes by exploiting chemistries such as glutaraldehyde coupling or carboxylic acid activation. These microsphere-analyte-COIN complexes can be separated from uncomplexed COINs using the flow characteristics of the microspheres or centrifugation. Thus, an analyte, complexed with a microsphere that is larger than the COINs used in the method, could be separated from unbound COINs in a fluid flow through a channel or microchannel because the larger microspheres move more slowly through the channel. Alternately, the microsphere carriers can be magnetic microspheres which can be separated from the reaction mixture by magnetic force. In this embodiment, free COINs are washed away and COINs complexed with the analyte and magnetic microsphere are left (FIG. 12). The complexes are then resuspended by removal of the magnetic field. Alternatively, the carrier microsphere beads can be separated from unbound COINs using affinity binding. In this embodiment, the microsphere bead contains an affinity ligand, such as biotin, that can be captured by a specific receptor, such as avidin. The complexed analyte is then separated from uncomplexed COINs through affinity attachment to a solid support and washing away of the uncomplexed COINs. Other types of affinity attachment ligands include lectin-sugar interactions, phage-displayed antibodies, or single chain antibodies with antigens. The complexes are then resuspended (for example, in 1×PBS buffer). The purified microsphere-analyte-COIN complexes are passed through a detection channel operably coupled with a Raman spectrometer. Optionally, the COINs can be separated from the analyte complex before detection. COINs can be separated from the complex using conditions such as high (>10) or low (<4) pH, low salt concentration (<1 mM), protease digestion, or using protein denaturing conditions such as heating (>50° C.) and high surfactant concentration (for example, >1% Tween™-20 or SDS), depending on the method of probe attachment. For example, if the probe is an antibody or other protein the forgoing conditions can be used to digest the complex, if the probe is a nucleic acid, conditions such a low salt solutions (<1 mM salt), heating to above the melting temperature of the probe-complementary strand complex, nuclease digestion, and binding replacement (by PNA, for example). Referring to FIG. 16, alternately, the detection can be carried out in a flow-through cell or in a vessel in which the sample contents are stirred so that an optical detector in a fixed position can detect all the analytes over a period of time. Magnetic microsphere beads are commercially available, for example, from Polysciences Inc., Warrington, Pa.; Dynal Biotech Inc., Brown Deer, Wis.; Magsphere, Inc., Pasadena, Calif.; and Bangs Laboratories, Inc., Fishers, Ind.

In a further embodiment, the microsphere beads contain an optical label that provides an additional method for detection, such as a fluorescent label that allows the microspheres to be fluorescently detected. In this embodiment, the sample is diluted sufficiently so that each detection cavity contains 1 or less analytes (normally this would represent a fL dilution). In this case, the co-occurrence of a COIN with a signal from a microsphere indicates the presence of the analyte. These types of microsphere beads are commercially available, for example, from Polysciences Inc., Warrington, Pa.; Molecular Probe, Eugene Oreg.; and Luminex Corporation, Austin, Tex.

In an additional embodiment, a known analyte in a sample is tagged with a set of two different COINs having unique Raman labels and the sample-containing solution is diluted for detection so that each detection cavity contains 1 or less particles (particles such as uncomplexed COINs, known analyte complexes, and uncomplexed analytes) normally this would represent a fL dilution). In this case, the statistically significant co-occurrence of at least two different COINs indicates the presence of a known analyte. Tagging occurs as above, through the selective complexation of a COIN-attached probe to the analyte. Thus, if antibodies are used as probes, the first uniquely labeled COIN is conjugated to antibodies that recognize a first epitope on the target molecule, and the second uniquely labeled COIN is conjugated to antibodies that recognize a second epitope on the same target molecule. In an alternate example, the first COIN is conjugated to a ligand and the second COIN is conjugated to an antibody that recognizes the receptor for the ligand.

In a further embodiment, two or more different known analytes are detected. In this embodiment, the known analytes are each tagged with a first and a second set of two different COINs having unique Raman labels, so that the statistically significant co-occurrence of a signal from the first set of two different COINs indicates the presence of a first known analyte and the co-occurrence of a signal from a second different set of two different COINs indicates the presence of a second known analyte. In this embodiment, the sample is diluted so that each detection cavity contains 1 or less particles (particles such as uncomplexed COINs, known analyte complexes, and uncomplexed analytes, normally this represents a fL dilution).

As discussed further below, Raman detection can be used to recognize the unique signatures of the complexed COINs in the sample.

In an additional embodiment of the invention, methods are provided for solution-based cellular detection and identification. In these aspects, one or more COINs are complexed with analytes on a target cell surface, uncomplexed COINs are separated from the cell(s), and COINs that are complexed to the cell surface are detected. Optionally, the cell may be fluorescently labeled and a fluorescence signal detected. In some embodiments, the detection of both a fluorescence signal and a Raman signature from a COIN is indicative of the presence of the cellular analyte. In other embodiments, the co-detection of unique signatures from two different COINs is indicative of the presence of a cellular analyte.

The detection target can be any type of animal or plant cell, or unicellular organism. For example, an animal cell could be a mammalian cell such as an immune cell, a cancer cell, a cell bearing a blood group antigen such as A, B, D, etc., or an HLA antigen, or virus-infected cell. Further, the target cell could be a microorganism, for example, bacterium, algae, virus, or protozoan. The feature recognized by the probe is present on the surface of the cell and the cell is detected by the presence of a known surface feature (the analyte) through the specific complexation of a COIN to the target cell-surface feature.

In an embodiment of the invention, a sample containing one or more cells is analyzed for the presence of a target cell presenting a known surface feature through the complexation of a uniquely labeled COIN to the known surface feature of the target cell. In an additional embodiment, a sample containing one or more cells is analyzed for the presence of cells presenting two or more known surface feature(s) and two sets of uniquely labeled COINs are complexed to a target cell so that the detection of each uniquely labeled COIN is indicative of the presence of each surface feature. In another embodiment, a sample containing one or more cells is analyzed for the presence of cells having three or more known surface features by the specific complexation of three or more sets of uniquely labeled COINs to a target cell so that the detection of a uniquely labeled COIN is indicative of the presence of a specific surface analyte. In addition, the cell may be optionally fluorescently labeled in these embodiments.

COINs that are useful as reporters for cellular analytes include those that are described herein. A set of COINs can be created in which each member of the set has a Raman signature unique to the set. In general, COINs are composed of clusters of metal particles containing organic Raman-active compounds. Additionally, the COINs may also include an adsorption layer (such as a BSA layer), a silica layer, a metal layer, an organic layer, or a combination thereof. Further, the COINs can be embedded in polymeric beads.

As discussed herein, exemplary probes include antibodies, antigens, receptors, inhibitors, activators, cofactors, cytokines, hormones, peptides, carbohydrates, ligands, nucleic acids, peptide nucleic acids, nucleic acids having modified nucleotides, and the like. As described above, the term antibody is used in its broadest sense to include polyclonal and monoclonal antibodies, as well as antigen binding fragments of such antibodies. An antibody useful the present invention, or an antigen binding fragment thereof, is characterized, for example, by having specific binding activity for an epitope of an analyte. An antibody, for example, includes naturally occurring antibodies as well as non-naturally occurring antibodies, including, for example, single chain antibodies, chimeric, bifunctional, and humanized antibodies, as well as antigen-binding fragments thereof. Such non-naturally occurring antibodies can be constructed using solid phase peptide synthesis, can be produced recombinantly, or can be obtained, for example, by screening combinatorial libraries consisting of variable heavy chains and variable light chains. These and other methods of making, for example, chimeric, humanized, CDR-grafted, single chain, and bifunctional antibodies are well known to those skilled in the art.

Cell surface target features include molecules that are part of, attached to, or protruding from the surface of a cell, such as, proteins, including receptors, antibodies, and glycoproteins, antigens, peptides, fatty acids, and carbohydrates. The cellular analyte may be found, for example, directly in a sample such as fluid from a target organism. The sample can be examined directly or may be pretreated to render the analyte more readily detectible. The fluid can be, for example, urine, blood, plasma, serum, saliva, semen, stool, sputum, cerebral spinal fluid, tears, mucus, and the like. The sample could also be, for example, tissue from a target organism.

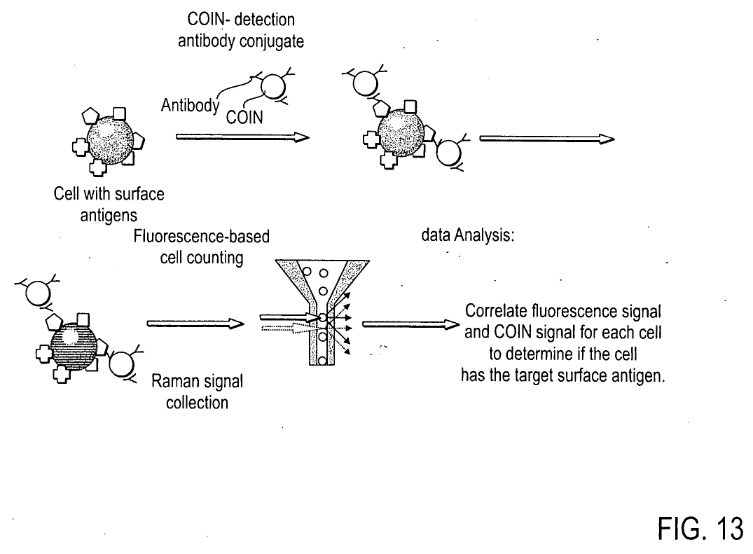

In an embodiment of the present invention, a cellular analyte solution is contacted with a COIN having a probe specific for a known cell surface antigen. For example, in FIG. 13, a cell is contacted with a COIN having attached antibody probes specific for a surface antigen. The COIN is complexed to the cell through the specific binding of the probe to a cell surface analyte. The cell is optionally fluorescently stained (FIG. 13). Typical fluorescent dyes that can be used for cellular staining include 1,4-diacetoxy-2,3-dicyano-benzene (ADB) (available from Sigma Chemicals, St. Louis, Mo.), 3,3-dihexyloxacarbocyanin (available from Eastman Kodak, Rochester, N.Y.), rhodamine 123 (available from Sigma Chemicals, St. Louis, Mo.), 2′,7′-dichlorofluorescin-diacetate (available from Sigma Chemicals, St. Louis Mo.), 2′,7′-dichlorofluorescein (available from Sigma Chemicals, St. Louis, Mo.), FLUO-3 AM cell permeant (available from Molecular Probes Inc., Eugene, Oreg.), acridine orange (available from Polysciences, Warrington, Pa.), propidium iodide (available from Sigma, St. Louis, Mo.), and hydroethidine (available from Polysciences, Warrington, Pa.). Fluorescent dyes typically stain cellular features, such as, outer membranes, mitochondrial membranes, proteins, and DNA and/or RNA. The cellular analytes are then separated from uncomplexed COINs (this can be accomplished in a fluid flow that allows the smaller uncomplexed COINs to travel faster with the flow than the larger cells, or through centrifugation that fractionates larger heavier complexed cells from uncomplexed COINs, for example) and passed through a detector cavity (FIG. 13) where the fluorescence from the dye and the Raman signal from the COIN are collected. Correlation of the COIN Raman signature with the fluorescent signal indicates that the cell surface is presenting the target antigen. Additionally, detection of fluorescent signal provides information regarding the total number of cellular analytes present in the sample. Alternately, the cell may be complexed with a second COIN having a Raman label that is different from the first. This Raman label may be complexed using a probe that is specific for the same or for a different cell surface feature as that recognized by the probe associated with the first COIN. The cellular analytes are then separated from uncomplexed COINs (this can be accomplished in a fluid flow that allows the smaller uncomplexed COINs to travel faster with the flow than the larger cells, through centrifugation that fractionates larger heavier complexed cells from uncomplexed COINs, or by dilution, for example) and passed through a detector cavity where the signals from the COINS are collected. Co-detection of two different COIN signatures indicates the presence of the target cell. If the unique COINs are associated with probes that are specific for different cell surface features, the co-occurrence of the two COIN signatures also indicates the presence of two different features on the cell surface. Optionally, the cells are also fluorescently stained. The detection of a fluorescence signal confirms the presence of cells and allows information to be acquired regarding the total number of cells present in the sample.

In an additional embodiment, three or more known possible features of a target cell are analyzed. In this embodiment the three or more known features are analyzed by tagging the cell with a set of COINs each of which has a unique Raman label and a probe specific for one of the three cell surface features. The unique COINs are contacted with the target cells so that each unique COIN binds specifically to a known feature, and the cellular analytes are then separated from uncomplexed COINs. (Alternately, the sample can be diluted so that each detection cavity contains 1 or less particles (normally this would represent a fL dilution)). In this case, the co-occurrence of the two different COINs indicates the presence of a cell in solution presenting two of the features recognized by the probes. The co-occurrence of three Raman signals indicates that a cell is presenting the three known cell surface features recognized by the probes. Optionally, the cells are also fluorescently stained. The detection of a fluorescent signal confirms the presence of cells and allows information to be acquired regarding the total number of cells present in the sample.

In a further embodiment, two or more types of cells are analyzed. Known features of two or more cells are analyzed by tagging the cells with a set of two or more COINs each member of the set having a unique Raman label and a probe specific for a unique surface feature of one of the cells. Optionally, the cells are fluorescently stained (as above). The cellular analytes are then separated from uncomplexed COINs (this can be accomplished in a fluid flow that allows the smaller uncomplexed COINs to travel faster with the flow than the larger cells, through centrifugation that fractionates larger heavier complexed cells from uncomplexed COINs, or by dilution, for example) and passed through a detector cavity where the Raman signals from the COINS are collected. If the cells have been fluorescently stained, the detection of both a fluorescent signal and a signal from a COIN indicates the presence of a cell presenting the known feature selectively bound by the probe associated with a unique COIN. Alternately, the two cells are tagged with a third unique COIN having a probe specific for one or more known surface feature(s) of the cells. The analytes are separated from uncomplexed COINs and passed through a cavity where Raman signal is detected. The co-detection of two unique COIN Raman signatures indicates the presence of a cell bearing the features selectively bound by the probes associated with the unique COINs detected. Optionally, the cells are also fluorescently stained and a fluorescent signal is also measured.

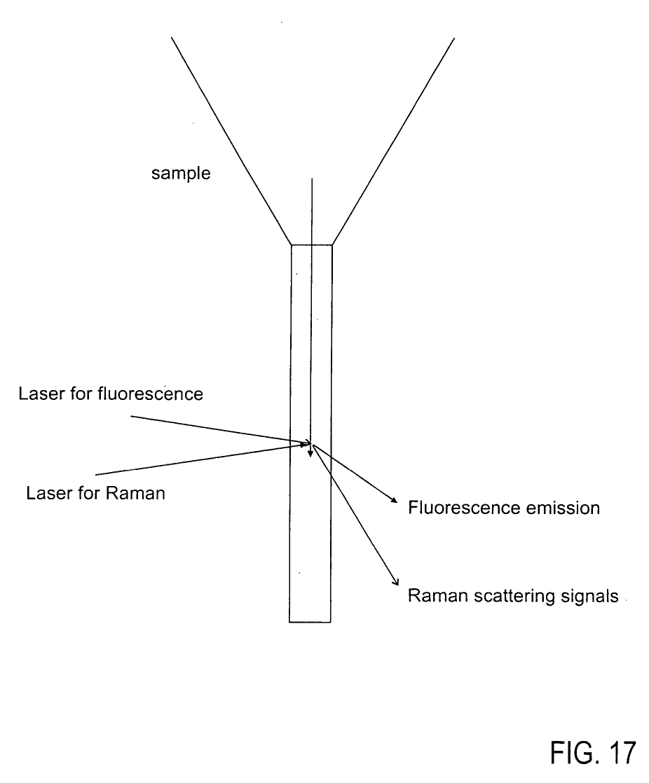

Detection can be carried out in a flow-through cell or in a vessel in which the sample contents are stirred so that an optical detector in a fixed position can detect all the analytes over a period of time. A schematic of a vessel in which the sample contents are stirred and Raman signal is measured is shown in FIG. 16. Similarly, FIG. 17 schematically illustrates a flow-through detector cell in which both fluorescence and Raman emission are collected.

In various embodiments of the invention, methods of analyte detection may be performed in an apparatus and/or system. In certain embodiments, the methods may be performed in a micro-electro-mechanical system (MEMS). MEMS are integrated systems comprising mechanical elements, sensors, actuators, and electronics. All of those components may be manufactured by known microfabrication techniques on a common chip, comprising a silicon-based or equivalent substrate. (See for example, Voldman et al., Ann. Rev. Biomed. Eng., 1:401-425, (1999).) The sensor components of MEMS may be used to measure mechanical, thermal, biological, chemical, optical and/or magnetic phenomena. The electronics may process the information from the sensors and control actuator components such as pumps, valves, heaters, coolers, and filters, thereby controlling the function of the MEMS.

The electronic components of MEMS may be fabricated using integrated circuit (IC) processes (for example, CMOS, Bipolar, or BICMOS processes). They may be patterned using photolithographic and etching methods known for computer chip manufacture. The micromechanical components may be fabricated using compatible micromachining processes that selectively etch away parts of the silicon wafer or add new structural layers to form the mechanical and/or electromechanical components.

Basic techniques in MEMS manufacture include depositing thin films of material on a substrate, applying a patterned mask on top of the films by photolithographic imaging or other known lithographic methods, and selectively etching the films. A thin film may have a thickness in the range of a few nanometers to 100 micrometers. Useful deposition techniques include chemical procedures such as chemical vapor deposition (CVD), electrodeposition, epitaxy, and thermal oxidation and physical procedures like physical vapor deposition (PVD) and casting. Methods for manufacture of nanoelectromechanical systems may be used for certain embodiments of the invention. (See, for example, Craighead, Science, 290:1532-36 (2000).)

In some embodiments of the invention, various methods may be performed in fluid filled compartments, such as microfluidic channels, nanochannels and/or microchannels. These and other components of the apparatus may be formed as a single unit, for example in the form of a chip, as known in semiconductor chips and/or microcapillary or microfluidic chips. Any materials known for use in such chips may be used in the apparatus, including silicon, silicon dioxide, silicon nitride, polydimethyl siloxane (PDMS), polymethylmethacrylate (PMMA), plastic, glass, quartz, and those having a gold surface layer, and the like.

Techniques for batch fabrication of chips are well known in the fields of computer chip manufacture and/or microcapillary chip manufacture. Such chips may be manufactured by any method known in the art, such as by photolithography and etching, laser ablation, injection molding, casting, molecular beam epitaxy, dip-pen nanolithography, chemical vapor deposition (CVD) fabrication, electron beam or focused ion beam technology or imprinting techniques. Non-limiting examples include conventional molding with a flowable, optically clear material such as plastic or glass; photolithography and dry etching of silicon dioxide; electron beam lithography using polymethylmethacrylate resist to pattern an aluminum mask on a silicon dioxide substrate, followed by reactive ion etching. Methods for manufacture of nanoelectromechanical systems may be used for certain embodiments of the invention. (See, for example, Craighead, Science, 290:1532-36 (2000).) Various forms of microfabricated chips are commercially available from, for example, Caliper Technologies Inc. (Mountain View, Calif.) and ACLARA BioSciences Inc. (Mountain View, Calif.).

In certain embodiments of the invention, part or all of the apparatus may be selected to be transparent to electromagnetic radiation at the excitation and emission frequencies used for Raman spectroscopy, such as glass, silicon, quartz or any other optically clear material. For fluid-filled compartments that may be exposed to various analytes, such as proteins, peptides, nucleic acids, nucleotides and the like, the surfaces exposed to such molecules may be modified by coating, for example to transform a surface from a hydrophobic to a hydrophilic surface and/or to decrease adsorption of molecules to a surface. Surface modification of common chip materials such as glass, silicon, quartz and/or PDMS is known in the art (for example, U.S. Pat. No. 6,263,286). Such modifications may include, but are not limited to, coating with commercially available capillary coatings (Supelco, Bellafonte, Pa.), silanes with various functional groups, such as polyethyleneoxide or acrylamide, or any other coating known in the art.

As discussed further below, Raman detection can be used to recognize the unique signatures of the COINs in the sample.

In additional embodiments, a device for fluid-based detection of an analyte in a sample includes a detection cell adapted to hold a fluid sample containing the analyte having a window, a Raman spectrometer, and a computer capable of running an algorithm for deconvoluting two or more enhanced Raman signals so that quantitative measurements of analyte concentrations can be made based on an enhanced Raman signal from a label complexed with an analyte. Optionally, the device may also be equipped with a fluorescence detector. In another embodiment, there is provided a kit for the detection of two or more analytes in solution that includes two or more different types of COINs, each of which type has a unique Raman label and a unique probe specific for an analyte, and a set of two or more different microspheres each member of the set having a probe specific for one of the analytes. Optionally, the microspheres are magnetic or fluorescently labeled or are COIN-containing microspheres.

A variety of techniques can be used to analyze COINs. Such techniques include, for example, nuclear magnetic resonance spectroscopy (NMR), photon correlation spectroscopy (PCS), IR, surface plasma resonance (SPR), XPS, scanning probe microscopy (SPM), SEM, TEM, atomic absorption spectroscopy, elemental analysis, UV-vis, fluorescence spectroscopy, and the like.

In the practice of the present invention, the Raman spectrometer can be part of a detection unit designed to detect and quantify nanoparticles of the present invention by Raman spectroscopy. Methods for detection of Raman labeled analytes, for example nucleotides, using Raman spectroscopy are known in the art. (See, for example, U.S. Pat. Nos. 5,306,403; 6,002,471; 6,174,677). Variations on surface enhanced Raman spectroscopy (SERS), surface enhanced resonance Raman spectroscopy (SERRS) and coherent anti-Stokes Raman spectroscopy (CARS) have been disclosed.

A non-limiting example of a Raman detection unit is disclosed in U.S. Pat. No. 6,002,471. An excitation beam is generated by either a frequency doubled Nd:YAG laser at 532 nm wavelength or a frequency doubled Ti:sapphire laser at 365 nm wavelength. Pulsed laser beams or continuous laser beams may be used. The excitation beam passes through confocal optics and a microscope objective, and is focused onto the flow path and/or the flow-through cell. The Raman emission light from the labeled nanoparticles is collected by the microscope objective and the confocal optics and is coupled to a monochromator for spectral dissociation. The confocal optics includes a combination of dichroic filters, barrier filters, confocal pinholes, lenses, and mirrors for reducing the background signal. Standard full field optics can be used as well as confocal optics. The Raman emission signal is detected by a Raman detector, which includes an avalanche photodiode interfaced with a computer for counting and digitization of the signal.

Another example of a Raman detection unit is disclosed in U.S. Pat. No. 5,306,403, including a Spex Model 1403 double-grating spectrophotometer with a gallium-arsenide photomultiplier tube (RCA Model C31034 or Burle Industries Model C3103402) operated in the single-photon counting mode. The excitation source includes a 514.5 nm line argon-ion laser from SpectraPhysics, Model 166, and a 647.1 nm line of a krypton-ion laser (Innova 70, Coherent).

Alternate excitation sources include a nitrogen laser (Laser Science Inc.) at 337 nm and a helium-cadmium laser (Liconox) at 325 nm (U.S. Pat. No. 6,174,677), a light emitting diode, an Nd:YLF laser, and/or various ions lasers and/or dye lasers. The excitation beam may be spectrally purified with a bandpass filter (Corion) and may be focused on the flow path and/or flow-through cell using a 6× objective lens (Newport, Model L6X). The objective lens may be used to both excite the Raman-active organic compounds of the COINs and to collect the Raman signal, by using a holographic beam splitter (Kaiser Optical Systems, Inc., Model HB 647-26N18) to produce a right-angle geometry for the excitation beam and the emitted Raman signal. A holographic notch filter (Kaiser Optical Systems, Inc.) may be used to reduce Rayleigh scattered radiation. Alternative Raman detectors include an ISA HR-320 spectrograph equipped with a red-enhanced intensified charge-coupled device (RE-ICCD) detection system (Princeton Instruments). Other types of detectors may be used, such as Fourier-transform spectrographs (based on Michaelson interferometers), charged injection devices, photodiode arrays, InGaAs detectors, electron-multiplied CCD, intensified CCD and/or phototransistor arrays.

Any suitable form or configuration of Raman spectroscopy or related techniques known in the art may be used for detection of the nanoparticles of the present invention, including but not limited to normal Raman scattering, resonance Raman scattering, surface enhanced Raman scattering, surface enhanced resonance Raman scattering, coherent anti-Stokes Raman spectroscopy (CARS), stimulated Raman scattering, inverse Raman spectroscopy, stimulated gain Raman spectroscopy, hyper-Raman scattering, molecular optical laser examiner (MOLE) or Raman microprobe or Raman microscopy or confocal Raman microspectrometry, three-dimensional or scanning Raman, Raman saturation spectroscopy, time resolved resonance Raman, Raman decoupling spectroscopy or UV-Raman microscopy.

Fluorescence measurements can be made, for example, using a LS 55 from Perkin Elmer, a Nikon fluorescence microscope, or the 1100 Series Fluorescence Detector (available from Agilent) operably coupled to a detector cell.

In certain aspects of the invention, a system for detecting the nanoparticles of the present invention includes an information processing system. An exemplary information processing system may incorporate a computer that includes a bus for communicating information and a processor for processing information. The information processing and control system may further comprise any peripheral devices known in the art, such as memory, display, keyboard and/or other devices.

In particular examples, the detection unit can be operably coupled to the information processing system. Data from the detection unit may be processed by the processor and data stored in memory. Data on emission profiles for various Raman labels may also be stored in memory. The processor may compare the emission spectra from composite organic-inorganic nanoparticles in the flow path and/or flow-through cell to identify the Raman-active organic compound. The processor may analyze the data from the detection unit to deconvolute, for example, the individual spectra of the multiple Raman labels used. The information processing system may also perform standard procedures such as subtraction of background signals.

While certain methods of the present invention may be performed under the control of a programmed processor, in alternate embodiments of the invention, the methods may be fully or partially implemented by any programmable or hardcoded logic, such as Field Programmable Gate Arrays (FPGAs), TTL logic, or Application Specific Integrated Circuits (ASICs). Additionally, the disclosed methods may be performed by any combination of programmed general purpose computer components and/or custom hardware components.

Following the data gathering operation, the data will typically be reported to a data analysis operation. To facilitate the analysis operation, the data obtained by the detection unit will typically be analyzed using a digital computer such as that described above. Typically, the computer will be appropriately programmed for receipt and storage of the data from the detection unit as well as for analysis and reporting of the data gathered.

In certain embodiments of the invention, custom designed software packages may be used to analyze the data obtained from the detection unit. In alternative embodiments of the invention, data analysis may be performed, using an information processing system and publicly available software packages. Software useful in the present invention include ones having an algorithm for deconvoluting two or more Raman signatures so that quantitative measurements of analyte concentrations can be made based on detected signatures of COINs specifically complexed with analytes, such as ones capable of performing principle component analysis.

### EXAMPLE 1

Synthesis Considerations

Chemical Reagents: Biological reagents including anti-IL-2 and anti-IL-8 antibodies were purchased from BD Biosciences Inc. The capture antibodies were monoclonal antibodies generated from mouse. Detection antibodies were polyclonal antibodies generated from mouse and conjugated with biotin. Liquid salt solutions and buffers were purchased from Ambion, Inc. (Austin, Tex., USA), including 5 M NaCl, 10×PBS (1×PBS 137 mM NaCl, 2.7 mM KCl, 8 mM Na₂HPO₄, and 2 mM KH₂PO₄, pH 7.4). Unless otherwise indicated, all other chemicals were purchased, at highest available quality, from Sigma Aldrich Chemical Co. (St. Louis, Mo., USA). Deionized water used for experiments had a resistance of 18.2×10⁶ Ohms-cm and was obtained with a water purification unit (Nanopure Infinity, Barnstad, USA).

Silver Seed Particle Synthesis: Stock solutions (0.5 M) of silver nitrate (AgNO₃) and sodium citrate (Na₃Citrate) were filtered twice through 0.2 micron polyamide membrane filters (Schleicher and Schuell, NH, USA) which were thoroughly rinsed before use. Sodium borohydrate solution (50 mM) was made fresh and used within 2 hours. Silver seed particles were prepared by rapid addition of 50 mL of Solution A (containing 8.00 mM Na₃Citrate, 0.60 mM sodium borohydrate and 2.00 mM sodium hydroxide) into 50 mL of Solution B (containing 4.00 mM silver nitrate) under vigorous stirring. Addition of Solution B into Solution A lead to a more polydispersed suspension. Silver seed suspensions were stored in the dark and used within one week. Before use, the suspension was analyzed by Photon Correlation Spectroscopy (PCS, Zetasizer 3000 HS, Malvern) to ensure the intensity-averaged diameter (z-average) was between 10-12 nm with a polydispersity index of <0.25.

Gold Seed Particle Synthesis: A household microwave oven (1350 W, Panasonic) was used to prepare gold nanoparticles. Typically, 40 mL of an aqueous solution containing 0.5 mM HAuCl₄ and 2.0 mM sodium citrate in a glass bottle (100 mL) was heated to boiling in the microwave using the maximum power, followed by a lower power setting to keep the solution gently boiling for 5 min. 2.0 grams of PTFE boiling stones (6 mm, Saint-Gobain A1069103, through VWR) were added to the solution to promote gentle and efficient boiling. The resultant solutions had a rosy red color. Measurements by PCS showed that the gold solutions had a typical z-average of 13 nm with a polydispersity index of <0.04.

COIN Synthesis:

In general, Raman labels were pipetted into the COIN synthesis solution to yield final concentrations of the labels in synthesis solution of about 1 to about 50 μM. In some cases, acid or organic solvents were used to enhance label solubility. For example, 8-aza-adenine and N-benzoyladenine were pipetted into the COIN formation reaction as 1.00 mM solutions in 1 mM HCl, 2-mercapto-benzimidazole was added from a 1.0 mM solution in ethanol, and 4-amino-pyrazolo[3,4-d]pyrimidine and zeatin were added from a 0.25 mM solution in 1 mM HNO₃.

Reflux Method: To prepare COIN particles with silver seeds, typically, 50 mL silver seed suspension (equivalent to 2.0 mM Ag⁺) was heated to boiling in a reflux system before introducing Raman labels. Silver nitrate stock solution (0.50 M) was then added dropwise or in small aliquots (50-100 μL) to induce the growth and aggregation of silver seed particles. Up to a total of 2.5 mM silver nitrate could be added. The solution was kept boiling until the suspension became very turbid and dark brown in color. At this point, the temperature was lowered quickly by transferring the colloid solution into a glass bottle. The solution was then stored at room temperature. The optimum heating time depended on the nature of Raman labels and amounts of silver nitrate added. It was found helpful to verify that particles had reached a desired size range (80-100 nm on average) by PCS or UV-Vis spectroscopy before the heating was arrested. Normally, the dark brown color was an indication of cluster formation and associated Raman activity.

To prepare COIN particles with gold seeds, typically, gold seeds were first prepared from 0.25 mM HAuCl₄ in the presence of a Raman label (for example, 20 μM 8-aza-adenine). After heating the gold seed solution to boiling, silver nitrate and sodium citrate stock solutions (0.50 M) were added, separately, so that the final gold suspension contained 1.0 mM AgNO₃ and 1.0 mM sodium citrate. Silver chloride precipitate might form immediately after silver nitrate addition but disappeared soon with heating. After boiling, an orange-brown color developed and stabilized. An additional aliquot (50-100 μL) of silver nitrate and sodium citrate stock solutions (0.50 M each) was added to induce the development of a green color, which was the indication of cluster formation and was associated with Raman activity.

Note that the two procedures produced COINs with different colors, primarily due to differences in the size of primary particles before cluster formation.

Oven Method: COINs could also be prepared conveniently by using a convection oven. Silver seed suspension was mixed with sodium citrate and silver nitrate solutions in a 20 mL glass vial. The final volume of the mixture was typically 10 mL, which contained silver particles (equivalent to 0.5 mM Ag⁺), 1.0 mM silver nitrate and 2.0 mM sodium citrate (including the portion from the seed suspension). The glass vials were incubated in the oven, set at 95° C., for 60 min before being stored at room temperature. A range of label concentrations could be tested at the same time. Batches showing brownish color with turbidity were tested for Raman activity and colloidal stability. Batches with significant sedimentation (which occurred when the label concentrations were too high) were discarded. Occasionally, batches that did not show sufficient turbidity could be kept at room temperature for an extended period of time (up to 3 days) to allow cluster formation. In many cases, suspensions became more turbid over time due to aggregation, and strong Raman activity developed within 24 hours. A stabilizing agent, such as bovine serum albumin (BSA), could be used to stop the aggregation and stabilize the COIN particles.

A similar approach was used to prepare COINs with gold cores. Briefly, 3 mL of gold suspensions (0.50 mM Au³⁺) prepared in the presence of Raman labels was mixed with 7 mL of silver citrate solution (containing 5.0 mM silver nitrate and 5.0 mM sodium citrate before mixing) in a 20 mL glass vial. The vial was placed in a convection oven and heated to 95° C. for 1 hour. Different concentrations of labeled gold seeds could be used simultaneously in order to produce batches with sufficient Raman activities. It should be noted that a COIN sample can be heterogeneous in terms of size and Raman activity. We typically used centrifugation (200-2,000×g for 5-10 min) or filtration (300 kDa, 1000 kDa, or 0.2 micron filters, Pall Life Sciences through VWR) to enrich for particles in the range of 50-100 nm. It is recommended to coat the COIN particles with a protection agent (for example, BSA, antibody) before enrichment. Some lots of COINs that we prepared (with no further treatment after synthesis) were stable for more than 3 months at room temperature without noticeable changes in physical and chemical properties.

Cold Method: 100 mL of silver particles (1 mM silver atoms) were mixed with 1 mL of Raman label solution (typically 1 mM). Then 5 to 10 mL of 0.5 M LiCl solution was added to induce silver aggregation. As soon as the suspension became visibly darker (due to aggregation), 0.5% BSA was added to inhibit the aggregation process. Afterwards, the suspension was centrifuged at 4500 g for 15 minutes. After removing the supernatant (mostly single particles), the pellet was resuspended in 1 mM sodium citrate solution. The washing procedure was repeated for a total of three times. After the last washing, the resuspended pellets were filtered through 0.2 μM membrane filter to remove large aggregates. The filtrate was collected as COIN suspension. The concentrations of COINs were adjusted to 1.0 or 1.5 mM with 1 mM sodium citrate by comparing the absorbance at 400 nm with 1 mM silver colloids for SERS.

Coating Particles with BSA: COIN particles were coated with an adsorption layer of BSA by adding 0.2% BSA to the COIN synthesis solution when the desired COIN size was reached. The addition of BSA inhibited further aggregation.

Crosslinking the BSA Coating: The BSA adsorption layer was crosslinked with glutaraldehyde followed by reduction with NaBH₄. Crosslinking was accomplished by transferring 12 mL of BSA coated COINs (having a silver concentration of about 1.5 mM) into a 15 mL centrifuge tube and adding 0.36 g of 70% glutaraldehyde and 213 μL of 1 mM sodium citrate. The solution was mixed well and allowed to sit at room temperature for about 10 min. before it was placed in a refrigerator at 4° C. The solution remained at 4° C. for at least 4 hours and then 275 μL of freshly prepared NaBH₄ (1 M) was added. The solution was mixed and left at room temperature for 30 min. The solution was then centrifuged at 5000 rpm for 60 min. The supernatant was removed with a pipette, leaving about 1.2 mL of liquid and the pellet in the centrifuge tube. 0.8 mL of 1 mM sodium citrate was added to yield a final volume of 2.0 mL. The coated COINs were purified by FPLC size-exclusion chromatography on a crosslinked agarose column.

Particle Size Measurement: The sizes of silver and gold seed particles as well as COINs were determined by using Photon Correlation Spectroscopy (PCS, Zetasizer3 3000 HS or Nano-ZS, Malvern). All measurements were conducted at 25° C. using a He—Ne laser at 633 nm. Samples were diluted with deionized water when necessary. For example, FIG. 8A illustrates the zeta potential of silver particles as a function of 8-aza-adenine concentration. FIG. 8B illustrates a time evolution of aggregate size (z-average) in the presence of 20 μM 8-aza-adenine.

Raman Spectral Analysis: for all SERS and COIN assays in solution, a Raman microscope (Renishaw, UK) equipped with a 514 nm Argon ion laser (25 mW) was used. Typically, a drop (50-200 μL) of a sample was placed on an aluminum surface. The laser beam was focused on the top surface of the sample meniscus and photons were collected for 10-20 second. The Raman system normally generated about 600 counts from methanol at 1040 cm⁻¹ for 10 second collection time. For Raman spectroscopy detection of analyte immobilized on surface, Raman spectra were recorded using a Raman microscope built in-house. This Raman microscope consisted of a water cooled Argon ion laser operating in continuous-wave mode, a dichroic reflector, a holographic notch filter, a Czerny-Turner spectrometer, and a liquid nitrogen cooled CCD (charge-coupled device) camera. The spectroscopy components were coupled with a microscope so that the microscope objective focused the laser beam onto a sample, and collected the back-scattered Raman emission. The laser power at the sample was ˜60 mW. All Raman spectra were collected with 514 nm excitation wavelength.

Conjugation of Coin Particles with Antibodies

A 500 uL solution containing 2 ng of a biotinylated anti-human antibody (anti-IL-2 or anti-IL-8) in 1 mM sodium citrate (pH 9) was mixed with 500 uL of a COIN solution (made with 8-aza-adenine or N-benzoyl-adenine); the resulting solution was incubated at room temperature for 1 hour, followed by adding 100 uL of PEG-400 (polyethyleneglycol-400). The solution was incubated at room temperature for another 30 min, then 200 uL of 1% Tween™-20 was added to the solution. The solution was centrifuged at 2000×g for 10 min. After removing the supernatant, the pellet was resuspended in 1 mL solution (BSAT) containing 0.5% BSA, 0.1% Tween-20 and 1 mM sodium citrate. The solution was then centrifuged at 1000×g for 10 min. The BSAT washing procedure was repeated for a total of 3 times. The final pellet was resuspended in 700 uL of diluting solution (0.5% BSA, 1×PBS, 0.05% Tween™-20). The Raman activity of the COINs was measured and adjusted to a specific activity of about 500 photon counts per μl per 10 seconds using a Raman spectroscope that generated about 600 counts from methanol at 1040 cm⁻¹ for 10 second collection time.

Confirmation of Antibody-COIN Conjugation: To obtain a standard curve, ELISA experiments were performed according to manufacture's instruction (BD Bioscences), using immobilized capture antibody, fixed analyte concentration (5 ng/mL IL-2 protein) and a serially diluted detection antibody (0, 0.01, 0.1, 1, and 10 ug/mL). After detection antibody binding, streptavidin-HRP (Horse Radish Peroxidase) was then reacted with the biotinylated detection antibodies and TMB (Tetramethyl Benzidine) substrate was applied followed by UV absorption measurement. A standard curve was generated by plotting absorption values against antibody concentrations.

To estimate the amount of antibody molecules that could be attached to a COIN particle, a similar ELISA experiment was then performed with COIN conjugated to a detection antibody. The ELISA data were collected and the binding activity of the COIN-antibody conjugate was compared with the standard curve to estimate the equivalent amount of antibody in the COIN-antibody conjugate. Assuming that only one of the antibody molecules that had been conjugated to a COIN particle bound to an immobilized analyte, and that all biotin moieties associated with the COIN particle were bound by streptavidin-HRP. Finally, the number of antibody molecules per COIN was estimated by dividing the equivalent amount of antibody in the COIN-antibody by the estimated number of COIN particle. We estimated that there could be as many as 50 antibody molecules on a COIN particle.

### EXAMPLE 2

Comparison of Raman Signals from SERS and COINs

For SERS testing, 100 μL silver colloids containing 8-aza-adenine (final 4 μM) was mixed with 100 μL of a test reagent chosen from the following: water (control), n-benzoyl adenine (10 μM), BSA (1%), Tween™-20 (1%), ethanol (100%). A resulting 200 μL mixture was then mixed with either 100 μL water (−Li), or 100 μL of 0.34 M LiCl (+Li) before the Raman scattering signal was measured with a Raman microscope. Raman signals were in arbitrary units and were normalized to respective maximums. The same procedure was used for testing COINs (made with 20 μM 8-aza-adenine), except that an additional 8-aza-adenine was not used. FIG. 3A shows SERS spectra of 8-aza-adenine (AA) with N-benzoyladenine (BA) as the test reagent. It can be seen from this Figure that salt was required for SERS signal and AA signal was suppressed by BA signal. FIG. 3B shows Raman spectra from COINs using BA as the test reagent, indicating that salt was not required for production of COINs signal and that salt reduced AA signal. Only a weak BA signal was detected when salt was added. FIG. 3C shows SERS spectra of 8-aza-adenine (AA) with BSA as the test reagent, showing that SERS signals were inhibited by BSA. FIG. 3D shows Raman spectra from COINs using BSA as the test reagent. It can be seen from these spectra that BSA had little negative effect on COINs and, in fact, may actually stabilize COINs. FIG. 3E shows SERS spectra of 8-aza-adenine (AA) with Tween™-20 as the test reagent, showing that a relatively strong SERS signal was detected in the absence of salt. FIG. 3F shows Raman spectra from COIN using Tween™-₂₀ as the test reagent, indicating that although Tween™-20 inhibited part of the COIN signal, it did partially compensate for the negative effect of salt. FIG. 3G shows SERS spectra of 8-aza-adenine with ethanol as the test reagent. These spectra demonstrate that salt was required for strong SERS signal and that 3 peaks (indicated by arrows) were enhanced by ethanol. FIG. 3H shows Raman spectra from COINs using ethanol as the test reagent, indicating that salt had a negative effect on the COIN signal and that no enhanced peaks were noticeable.

### EXAMPLE 3

Protein detection in solution using COINs is demonstrated in the following experiment:

A control experiment was performed by mixing 100 μL of unmodified magnetic beads (Polysciences Inc.) with 500 μL of 1 nM COIN(AAD) in 1×PBS buffer. The suspension was incubated for 30 minutes at 37° C. The magnetic beads and the supernatant were separated magnetically according to the vendor protocol. The beads were washed with 1 mL 1×PBS and re-suspended in 500 μL of 1×PBS.

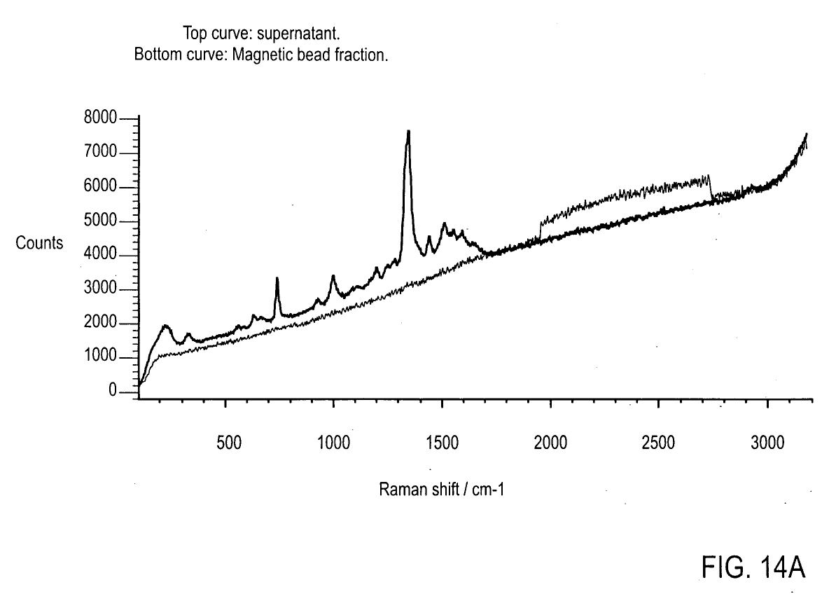

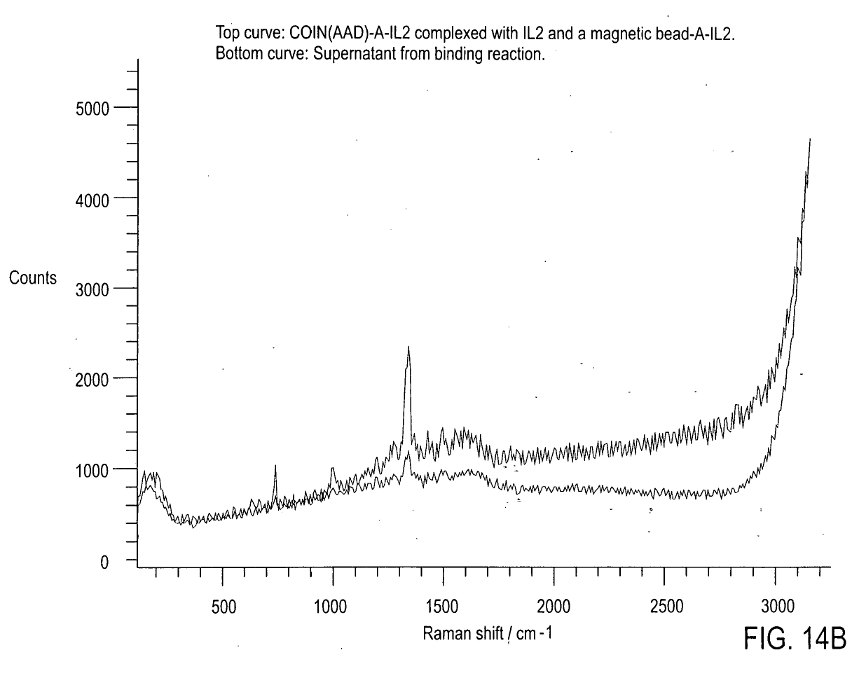

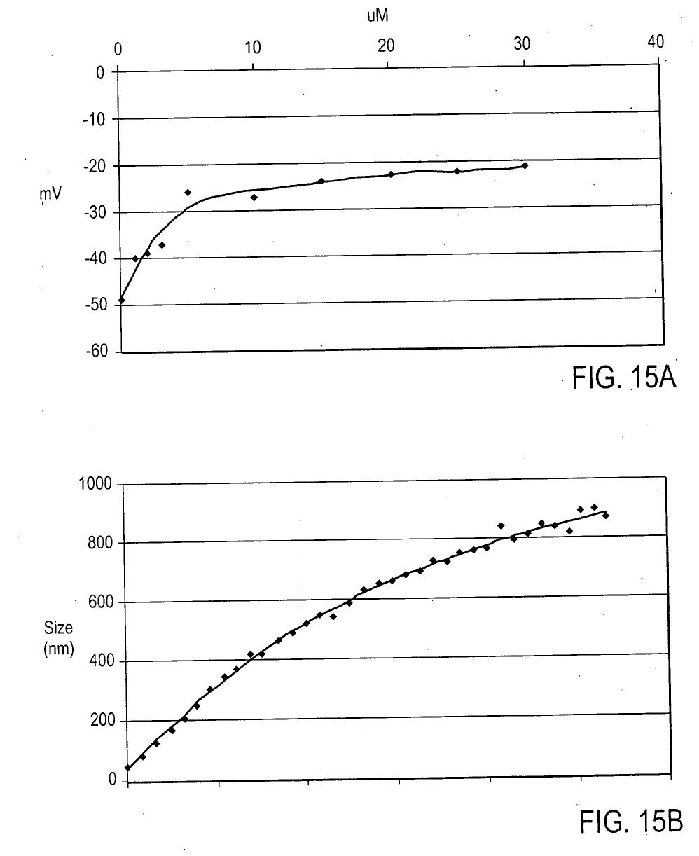

Raman measurements of the suspended beads and the supernatant were performed on a Raman spectroscope (Renishaw Transdeucer Systems Ltd., UK) equipped with 514 nm Argon ion laser (50 mW). Typically, a drop (50 μL) of a sample was placed on an aluminum surface. The laser beam was focused on the top surface of the sample and photons were collected for 10 seconds. The result is charted in FIG. 14. As can be seen from FIG. 14A, no COIN signal was observed from the fraction containing the resuspended magnetic beads (bottom curve), and a strong signal was seen from the supernatant (top curve), thus indicating that the COINs were not bound to the magnetic beads.

In a second experiment, anti-IL2 was immobilized to carboxylate-modified magnetic bead (Polysciences Inc.) through an EDC coupling reaction. COIN(AAD) and its anti-IL2 antibody (COIN(AAD)-A-IL2) conjugate were prepared according to the protocol described in Example 1. 100 μL of anti-IL2-modified magnetic beads were mixed with 500 μL of 1 nM COIN(AAD)-A-IL2 in 1×PBS buffer and IL2 (10 ng/μL). The suspension was incubated for 30 minutes at 37° C. The separation and Raman measurement of the reaction product was performed as described above. The result is charted in FIG. 14B. In this experiment, the signal from COIN(AAD) decreased significantly in the supernatant (bottom curve), due to binding of the COINs to the magnetic beads. Instead, the majority of the signal from the COIN particles can be seen in the magnetic bead fraction (top curve), confirming that binding between the magnetic beads and the COIN(AAD)-Bt-a-IL2 occurred.

### EXAMPLE 4

Ganglioside molecules (for example, GM2, GD2, and GD3) are complex molecules containing carbohydrates and fats. When ganglioside molecules are incorporated into the outside membrane of a cell, they make the cell more easily recognized by antibodies. GM2 is a molecule expressed on the cell surface of a number of human cancers. GD2 and GD3 contain carbohydrate antigens expressed by human cancer cells. Antibodies against GM2 are conjugated to a COIN with a unique signature A, and antibodies against GD2 or GD3 are conjugated to a COIN having a unique signature B. Both antibody-conjugated COINs (each 10⁶ particles) are mixed with 0.1 mL serum sample collected from a human for 10 min. The mixture is then diluted 10× with 1×PBS (2×10⁵ COIN particles in 1 mL or 1×10¹² micron³). The diluted sample is then passed through a fluidic channel equipped with a Raman detector. Statistically the chance for 2 different COINs being detected together is low and a baseline can be established using normal samples. The appearance of signals from two or more unique COINs more frequently than statistically predicted, is indicative of the presence of cells presenting GM2 and GD2 (or GD3, depending on the antibody chosen) in the sample.

TABLE 1

| No. | Abbreviation | Name | Structure |
|---|---|---|---|
| 1 | AAD (AA) | 8-Aza-Adenine | 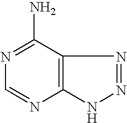 |
| 2 | BZA (BA) | N-Benzoyladenine | 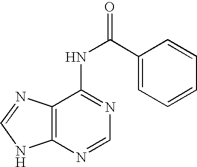 |
| 3 | MBI | 2-Mercapto-benzimidazole | 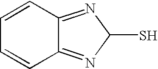 |
| 4 | APP | 4-Amino-pyrazolo[3,4- d]pyrimidine | 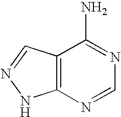 |
| 5 | ZEN | Zeatin | 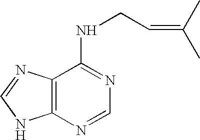 |
| 6 | MBL (MB) | Methylene Blue | 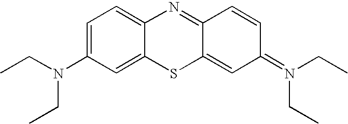 |
| 7 | AMA (AN,AM) | 9-Amino-acridine | 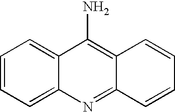 |
| 8 | EBR | Ethidium Bromide | 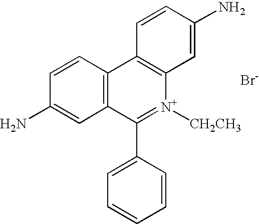 |
| 9 | BMB | Bismarck Brown Y | 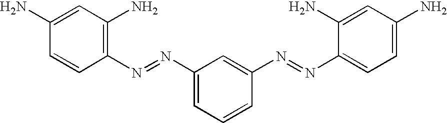 |
| 10 | NBA | N-Benzyl-aminopurine | 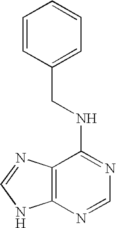 |
| 11 | THN | Thionin acetate | 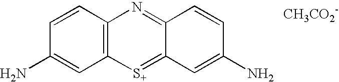 |
| 12 | DAH | 3,6-Diaminoacridine | 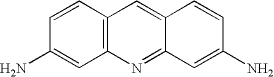 |
| 13 | GYP | 6-Cyanopurine | 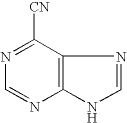 |
| 14 | AIC | 4-Amino-5-imidazole- carboxamide hydrochloride | 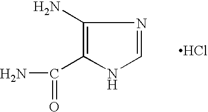 |
| 15 | DII | 1,3-Diiminoisoindoline | 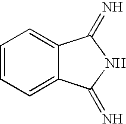 |
| 16 | R6G | Rhodamine 6G | 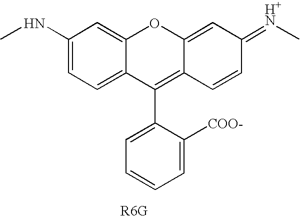 |
| 17 | CRV | Crystal Violet | 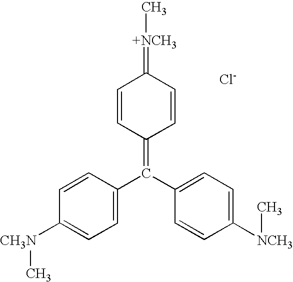 |
| 18 | BFU | Basic Fuchsin | 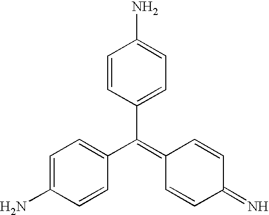 |
| 19 | ANB | Aniline Blue diammonium salt | 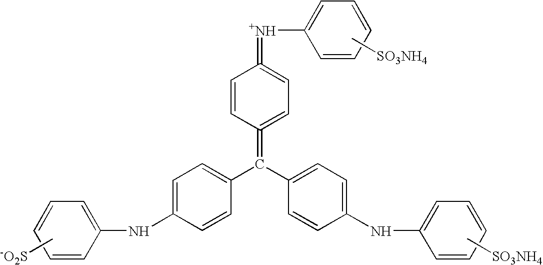 |
| 20 | ACA | N-[(3-(Anilinomethylene)-2- chloro-1-cyclohexen-1- yl)methylene]aniline monohydrochloride | 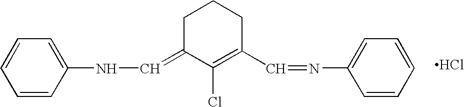 |
| 21 | ATT | O-(7-Azabenzotriazol-1-yl)- N,N,N′,N′-tetramethyluronium hexafluorophosphate | 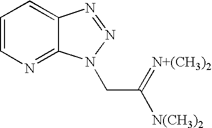 |
| 22 | AMF | 9-Aminofluorene hydrochloride | 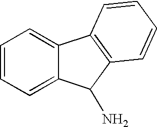 |
| 23 | BBL | Basic Blue | 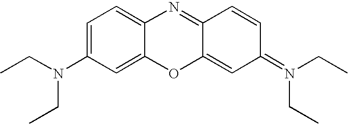 |
| 24 | DDA | 1,8-Diamino-4,5- dihydroxyanthraquinone | 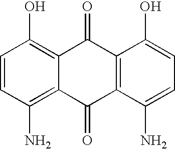 |
| 25 | PFV | Proflavine hemisulfate salt hydrate | 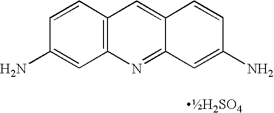 |
| 26 | APT | 2-Amino-1,1,3- propenetricarbonitrile | 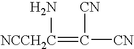 |
| 27 | VRA | Variamine Blue RT Salt | 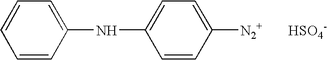 |
| 28 | TAP | 4,5,6-Triaminopyrimidine sulfate salt | 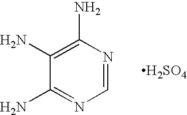 |
| 29 | ABZ | 2-Amino-benzothiazole | 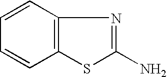 |
| 30 | MEL | Melamine | 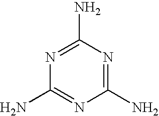 |
| 31 | PPN | 3-(3-Pyridylmethylamino) propionitrile | 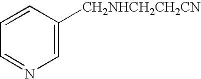 |
| 32 | SSD | Silver(I) sulfadiazine | 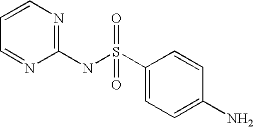 |
| 33 | AFL | Acriflavine | 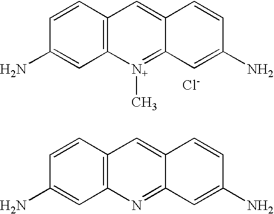 |
| 34 | AMPT | 4-Amino6- Mercaptopyrazolo[3,4- d]pyrimidine | 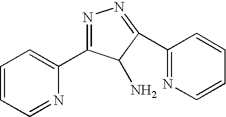 |
| 35 | APU | 2-Am-Purine | 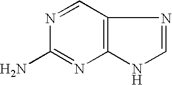 |
| 36 | ATH | Adenine Thiol | 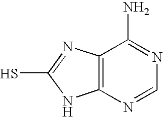 |
| 37 | FAD | F-Adenine | 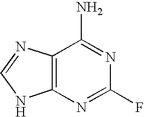 |
| 38 | MCP | 6-Mercaptopurine | 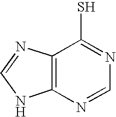 |
| 39 | AMP | 4-Amino-6- mercaptopyrazolo[3,4- d]pyrimidine | 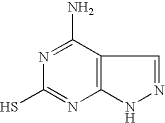 |
| 41 | R110 | Rhodamine 110 | 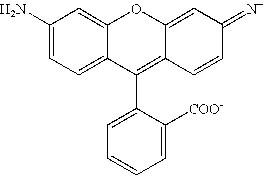 |
| 42 | ADN | Adenine | 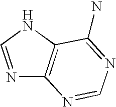 |
| 43 | AMB | 5-amino-2- mercaptobenzimidazole | 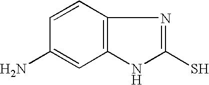 |

What is claimed is:

1.) A method for detecting a known analyte in a sample, the method comprising:
contacting a sample containing an analyte with nanoclusters of metal particles having a unique Raman signature produced by at least one Raman active organic compound incorporated in the nanoclusters and an attached probe specific for the known analyte;
contacting the sample containing the analyte with microspheres having an attached probe specific for the known analyte;
separating the microsphere in the solution from any uncomplexed nanoclusters;
detecting Raman signals from a fluid solution containing the microsphere,
wherein detection of the Raman signature from the nanocluster is indicative of the presence of the analyte.

2.) The method of claim 1 wherein the nanocluster has an average diameter of about 40 nm to about 200 nm.

3.) The method of claim 1 wherein the nanocluster has an average diameter of about 50 nm to about 150 nm.

4.) The method of claim 1 wherein the nanocluster has a silica coating and is comprised of at least one metal selected from the group consisting of copper, silver, gold, and aluminum.

5.) The method of claim 1 wherein the nanocluster has a bovine serum albumen coating and is comprised of at least one metal selected from the group consisting of copper, silver, gold, and aluminum.

6.) The method of claim 1 wherein the probe is selected from the group consisting of antibodies, antigens, polynucleotides, oligonucleotides, receptors, carbohydrates, and ligands.

7.) The method of claim 4 wherein the known analyte is a protein and the probe is an antibody specific for the known protein analyte.

8.) The method of claim 1 wherein the microsphere contains a fluorescent compound and the detection of both a fluorescent signal from the microsphere and a Raman signature from the nanocluster is indicative of the presence of the known analyte in the sample.

9.) The method of claim 1 wherein the microsphere is magnetic and separating occurs by magnetic force.

10.) The method of claim 1 wherein the nanoclusters of metal particles contain two or more different organic compounds capable of being detected by Raman spectroscopy incorporated therein.

11.) A method for detecting the presence of two or more known analytes in a sample, the method comprising:
contacting a sample comprising two or more analytes with a set of nanoclusters of metal particles, each member of the set having a Raman signature unique to the set produced by at least one Raman active organic compound incorporated in the nanoclusters and each member having an attached probe specific for a known analyte;
contacting the sample containing the analytes with microspheres having attached probes specific for the known analytes;
separating the microspheres from any uncomplexed nanoclusters;
detecting Raman signals from a fluid solution containing the microspheres,
wherein the detection of a unique Raman signature from a nanocluster is indicative of the presence of a specific known analyte.

12.) The method of claim 11 wherein the nanoclusters have an average diameter of about 40 nm to about 200 nm.

13.) The method of claim 11 wherein the nanoclusters have an average diameter of about 50 nm to about 200 nm.

14.) The method of claim 11 wherein the nanoclusters have a silica layer and the metal particles are comprised of a metal selected from the group consisting of copper, silver, gold, and aluminum.

15.) The method of claim 11 wherein the nanoclusters additionally are comprised of a surface-adsorbed protein and the metal particles are comprised of a metal selected from the group consisting of copper, silver, gold, and aluminum.

16.) The method of claim 11 wherein the probes are selected from the group consisting of antibodies, antigens, polynucleotides, oligonucleotides, receptors, carbohydrates, and ligands.

17.) The method of claim 11 wherein the known analytes are proteins and the probes are antibodies specific for the protein analytes.

18.) The method of claim 11 wherein the microspheres contain a fluorescent compound and the concurrent detection of a fluorescent signal from the microsphere and a Raman signature from the nanocluster is indicative of the presence of a known analyte in the sample.

19.) The method of claim 11 wherein the microspheres are magnetic and separating occurs by magnetic force.

20.) The method of claim 11 wherein at least one member of the set of nanoclusters of metal particles contains two or more different organic compounds capable of being detected by Raman spectroscopy incorporated in the nanocluster.

21.) A method for detecting the presence of three or more known analytes in a sample, the method comprising:
contacting a sample comprising a plurality of analytes with a set of nanoclusters of metal particles, each member of the set having a Raman signature unique to the set produced by at least one Raman active organic compound incorporated in the nanoclusters and each member having an attached probe specific for a known analyte;
contacting the sample containing the analytes with microspheres having attached probes specific for the known analytes;
separating the microspheres from any uncomplexed nanoclusters;
detecting a Raman signal from a fluid solution containing the microspheres,
wherein the detection of a unique Raman signature from a nanocluster is indicative of the presence of a specific known analyte.

22.) The method of claim 21 wherein the nanoclusters have an average diameter of about 40 nm to about 200 nm.

23.) The method of claim 21 wherein the nanoclusters have an average diameter of about 50 nm to about 150 nm.

24.) The method of claim 21 wherein the nanoclusters have a bovine serum albumen or silica coating and the metal particles are comprised of a metal selected from the group consisting of copper, silver, gold, and aluminum.

25.) The method of claim 21 wherein the nanoclusters are embedded within polymeric beads and the beads comprise a polymer selected from the group consisting of polyolefins, polystyrenes, polyacrylates, and poly(meth)acrylates.

26.) The method of claim 21 wherein the probes are selected from the group consisting of antibodies, antigens, polynucleotides, oligonucleotides, receptors, carbohydrates, and ligands.

27.) The method of claim 22 wherein the known analytes are proteins and the probes are antibodies specific for the protein analytes.

28.) The method of claim 21 wherein the microspheres contain a fluorescent compound and the detection of both a fluorescent signal from the microsphere and a Raman signature from the nanocluster is indicative of the presence of a specific analyte in the sample.

29.) The method of claim 21 wherein the microspheres are magnetic and separating occurs by magnetic force.

30.) A method for detecting the presence of a known analyte in a sample, the method comprising:
contacting a sample containing an analyte with a first nanocluster of metal particles having a unique Raman signature produced by at least one Raman active organic compound incorporated in the nanocluster and having an attached probe specific for the known analyte;
contacting the sample containing the analyte with a second nanocluster of metal particles having a unique Raman signature produced by at least one Raman active organic compound incorporated in the nanocluster different from that of the first nanocluster and having an attached probe specific for the known analyte;
separating the known analyte from any uncomplexed nanoclusters;
detecting a Raman signal from a fluid solution, wherein the co-occurrence of a Raman signature from the first and second nanoclusters is indicative of the presence of the known analyte.

31.) The method of claim 30 wherein the nanoclusters have an average diameter of about 40 nm to about 200 nm.

32.) The method of claim 30 wherein the nanoclusters have an average diameter of about 50 nm to about 150 nm.

33.) The method of claim 30 wherein the nanoclusters have bovine serum albumen or silica coating and the metal particles are comprised of a metal selected from the group consisting of copper, silver, gold, and aluminum.

34.) The method of claim 30 wherein the nanoclusters are embedded within polymeric beads and the beads comprise a polymer selected from the group consisting of polyolefins, polystyrenes, polyacrylates, and poly(meth)acrylates.

35.) The method of claim 30 wherein the sample is a biological sample and the probes are selected from the group consisting of antibodies, antigens, polynucleotides, oligonucleotides, receptors, carbohydrates, and ligands.

36.) The method of claim 30 wherein the known analytes are proteins and the probes are antibodies specific for the protein analytes.

37.) A method for detecting the presence of two or more known analytes in a sample, the method comprising:
contacting a sample comprising two or more analytes with a first set of nanoclusters of metal particles, each member of the set having a Raman signature unique to the set produced by at least one Raman active organic compound incorporated in the nanoclusters and each member having an attached probe specific for a known analyte;
contacting the sample with a second set of nanoclusters of metal particles, each member of the set having a Raman signature unique to the set produced by at least one Raman active organic compound incorporated in the nanoclusters and each member having an attached probe specific for a known analyte;
separating analytes in the sample from any uncomplexed nanoclusters;
detecting a Raman signal from a fluid solution, wherein the co-occurrence of a Raman signature from the first set of nanoclusters and the second set of nanoclusters is indicative of the presence of a specific known analyte.

38.) The method of claim 37 wherein the nanoclusters have an average diameter of about 40 nm to about 200 nm.

39.) The method of claim 37 wherein the nanoclusters have an average diameter of about 50 nm to about 150 nm.

40.) The method of claim 37 wherein the nanoclusters have a bovine serum albumen or silica coating and the metal particles are comprised of a metal selected from the group consisting of copper, silver, gold, and aluminum.

41.) The method of claim 37 wherein the nanoclusters are embedded within polymeric beads and the beads comprise a polymer selected from the group consisting of polyolefins, polystyrenes, polyacrylates, and poly(meth)acrylates.

42.) The method of claim 37 wherein the probes are selected from the group consisting of antibodies, antigens, polynucleotides, oligonucleotides, receptors, carbohydrates, and ligands.

43.) The method of claim 37 wherein the known analytes are proteins and the probes are antibodies specific for the protein analytes.

44.) A method for detection of a known cellular analyte, the method comprising:
contacting a sample containing a cellular analyte with nanoclusters of metal particles having a Raman-active organic compound incorporated therein, and having an attached probe specific for a surface feature of the known cellular analyte;
separating the cellular analyte from any uncomplexed nanoclusters;
detecting a Raman signal from a solution containing the cellular analyte wherein the detection of a unique Raman signature is indicative of the presence of the known cellular analyte.

45.) The method of claim 44 wherein the nanocluster has an average diameter of about 40 nm to about 200 nm and are comprised of a metal selected from the group consisting of copper, silver, gold, and aluminum.

46.) The method of claim 45 wherein the nanocluster has an average diameter of about 50 nm to about 150 nm.

47.) The method of claim 44 wherein the nanoclusters are comprised of silver or gold.

48.) The method of claim 44 wherein the nanocluster has a bovine serum albumen, gold, polymer, or silica coating.

49.) The method of claim 44 wherein the probes are selected from the group consisting of antibodies, antigens, receptors, carbohydrates, and ligands.

50.) The method of claim 44 wherein the cell is fluorescently labeled.

51.) A method for the detection of a known cellular analyte, the method comprising:
contacting a sample containing a cellular analyte with a set of two composite organic inorganic nanoclusters, each member of the set having a Raman signature unique to the set produced by at least one Raman active organic compound incorporated in the nanoclusters and each member having an attached probe specific for a surface feature of the known cellular analyte;
separating the cellular analyte from any uncomplexed nanoclusters;
detecting a Raman signal from a solution containing the cellular analyte wherein the co-occurrence of at least two different unique Raman signatures is indicative of the presence of the known cellular analyte possessing at least one specific surface feature.

52.) The method of claim 51 wherein each member of the set of nanoclusters has an attached probe specific for a different feature of the cellular analyte.

53.) The method of claim 51 wherein the nanoclusters have an average diameter of about 40 nm to about 200 nm.

54.) The method of claim 51 wherein the nanoclusters have an average diameter of about 50 nm to about 150 nm.

55.) The method of claim 51 wherein the nanoclusters are comprised of gold or silver.

56.) The method of claim 51 wherein the nanoclusters have bovine serum albumen layer.

57.) The method of claim 51 wherein the probes are selected from the group consisting of antibodies, antigens, receptors, carbohydrates, and ligands.

58.) The method of claim 51 wherein the cell is fluorescently labeled and a fluorescence signal is detected.

59.) A device for fluid-based parallel detection of analytes in a sample, the device comprising:
a detection cell adapted to hold a fluid sample having at least one window;
a Raman spectrometer comprising an excitation source, optics capable of focusing incident and scattered light, and a detector; and
a computer capable of running an algorithm for deconvoluting two or more enhanced Raman signals so that quantitative measurements of analyte concentrations can be made based on an enhanced Raman signal from labels containing at least one Raman-active organic compound specifically complexed with the analytes.

60.) The device of claim 59 additionally comprising a UV-vis excitation source and a fluorescence emission detector.

61.) A kit for detecting a plurality of known analytes in solution comprising a set of two or more composite organic inorganic nanoclusters, each having a unique Raman signature produced by at least one Raman active organic compound incorporated in the nanocluster and a unique probe specific for a known analyte, and a set of microspheres each member having a probe specific a known analyte.

62.) The kit of claim 61 wherein the microspheres are magnetic or fluorescently labeled.

63.) The kit of claim 61 wherein the kit contains three or more composite organic inorganic nanoclusters.

64.) The kit of claim 61 wherein at least one composite organic inorganic nanocluster contains two or more different Raman active organic compounds.
